(19) United States
(12) Patent Application Publication
(10) Pub. No.: US 2007/0019511 A1
(43) Pub. Date: Jan. 25, 2007

(54) RECORDING APPARATUS, RECORDING METHODS, READING APPARATUS READING METHODS AND PROGRAMS

(75) Inventors: Masaaki ISOZAKI, Kanagawa (JP); Masaaki Fukuda, Saitama (JP); Kazuyuki Saito, Kanagawa (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: Sony Corporation, Tokyo (JP)

(21) Appl. No.: 11/457,663

(22) Filed: Jul. 14, 2006

(30) Foreign Application Priority Data
Jul. 21, 2005 (JP) 2005-211754

(51) Int. Cl. G11B 17/22

(52) U.S. Cl. 369/30.28

(57) ABSTRACT

A recording apparatus is disclosed which includes: a first recording medium configured to record a front portion included in the entire data of a content continuous along the time axis as a part of the content; a second recording medium configured to record a portion included in the entire data of the content as a part following the front portion recorded on the first recording medium; a third recording medium configured to record partial data of the content; and recording control means configured to control a process of recording data onto the third recording medium to record as much partial data of the content onto the third recording medium as data having a first data amount representing the amount of data, which can be read out from the third recording medium during a period to switch an operation to read out data from the first recording medium to the second recording medium.

### CROSS REFERENCES TO RELATED APPLICATION

The present invention contains subject matter related to Japanese Patent Application JP 2005-211754 filed in the Japanese Patent Office on Jul. 21, 2005, the entire contents of which being incorporated herein by reference.

### BACKGROUND OF THE INVENTION

1. Field of the Invention

The present invention relates to a recording apparatus, a recording method, a reading apparatus, a reading method and programs. More particularly, the present invention relates to a recording apparatus capable of recording a content onto a recording medium, a recording method adopted by the recording apparatus, a reading apparatus capable of reading out a content from a recording medium, a reading method adopted by the reading apparatus and programs implementing the recording and reading methods.

2. Description of the Related Art

There is a recording/reproduction system in which, by recording a content into a plurality of recording mediums and automating operations to mount the recording mediums onto a drive, a content having a large amount of data can be handled with ease.

FIG. 1 is a block diagram showing the configuration of the existing recording/reproduction system. In the configuration, a video/audio encoder 11 is an apparatus for coding picture data of a base band corresponding to a received input picture signal by adoption of an MPEG (Moving Pictures Experts Group) method. In addition, the video/audio encoder 11 also encodes sound data of a base band corresponding to a received input sound signal not shown in the figure by adoption of the MPEG method. The video/audio encoder 11 supplies data obtained as a result of the coding process to a stream encoder 12.

The stream encoder 12 is an apparatus for multiplexing pieces of encoded data from the video/audio encoder 11 in order to convert the encoded data into a stream conforming to an MPEG transport stream system or an MPEG program stream system and supplying the stream obtained as a result of the conversion process to a write buffer 13.

The write buffer 13 is a memory used for temporarily storing a data stream received from the stream encoder 12 before supplying the stored data stream to a drive 14.

The drive 14 is an apparatus for storing data received from the write buffer 13 onto an optical disk 15 mounted on the drive 14 as a data file.

A juke system 16 is a system for controlling operations to mount an optical disk 15 onto the drive 14 and dismount the optical disk 15 from the drive 14. The juke system 16 drives a picker 18 to select one of a plurality of optical disks 15 each accommodated in a disk slot 17. On the basis of control executed by the juke system 16, the picker 18 conveys the selected optical disk 15 to the drive 14 and mounts the conveyed optical disk 15 onto the drive 14. Also on the basis of control executed by the juke system 16, the picker 18 dismounts an optical disk 15 from the drive 14, conveys the dismounted optical disk 15 to a specific one of the disk slots 17 and puts the conveyed optical disk 15 in the specific disk slot 17. In this way, the juke system 16 controls the picker 18.

In addition, the drive 14 also reads out data stored as a file on an optical disk 15 mounted thereon and supplies the data read out from the optical disk 15 to a read buffer 19. Implemented typically as a semiconductor memory or a hard disk, the read buffer 19 is a memory for temporarily storing a data stream received from the drive 14. Playing a role to absorb jitters read out from the optical disk 15 and smooth a data flow by making the data rate constant, the read buffer 19 supplies a data stream stored therein to a stream decoder 20.

The stream decoder 20 is an apparatus for splitting the data stream conforming to the MPEG transport stream system or the MPEG program stream system into picture data and sound data and supplying the picture data and the sound data separated from each other to a video/audio decoder 21.

The video/audio decoder 21 is an apparatus for decoding coded picture data and coded sound data into the so-called base-band picture data and base-band sound data respectively. The video/audio decoder 21 supplies an output picture signal based on the base-band picture data obtained as a result of the decoding process and an output sound signal not shown based on the base-band sound data also obtained as a result of the decoding process to a monitor 22. The monitor 22 is an apparatus for displaying a picture based on the picture signal received from the video/audio decoder 21 and outputting a sound based on the picture signal also received from the video/audio decoder 21.

As a technique of recording data onto an optical disk 15, there are three conceivable methods shown in FIG. 2.

The first data recording method is a method of recording data of one content onto one optical disk 15 as shown in the upper diagram of FIG. 2. In accordance with the first data recording method, the data of a desired content can be taken out from one optical disk 15. However, the optical disk 15 most likely includes a free area or most likely used with a low degree of efficiency. In addition, if the amount of data of one content exceeds the storage capacity of one optical disk 15, the excessive data cannot be recorded on the optical disk 15.

The second data recording method is a method of recording data of one content onto one optical disk 15 by compressing the data so as to accommodate all the data in the storage area of the optical disk 15 in case the amount of the data of the content exceeds the storage capacity of the optical disk 15 as shown in the middle diagram of FIG. 2. In accordance with the second data recording method, in the case of a content with a large amount of data, a free area is hardly generated in the optical disk 15 or the optical disk 15 is used with a high degree of efficiency. Since the data may be compressed, however, the picture quality and the sound quality may inevitably deteriorate accordingly. On top of that, since a process to compress the data is added, the processing time becomes longer.

The third data recording method is a method of recording data of one content onto a plurality of optical disks 15 by spreading the data of the content over the optical disks 15 as shown in the middle diagram of FIG. 2. In accordance with the third data recording method, the data of one content can be recorded onto optical disks 15 even in case the amount of the data of the content exceeds the storage capacity of one optical disk 15.

In accordance with the third data recording method, however, an optical disk 15 mounted on the drive 14 has to be replaced with the next one in the course of reproduction of a content. Since the data of the content cannot be read out from an optical disk 15 while the optical disk 15 is being replaced with the next one, the reproduction processing may be suspended temporarily.

FIG. 3 shows a flowchart referred to in explanation of processing to read out the data of a content recorded on optical disks 15 in accordance with the third data recording method. At the first step S11, the picker 18 conveys an optical disk 15 from a disk slot 17 to the drive 14 and mounts the optical disk 15 on the drive 14. Subsequently, at the next step S12, a process to read out data from the optical disk 15 mounted on the drive 14 is started.

Then, at the next step S13, the data read out from the optical disk 15 is stored in the read buffer 19. Subsequently, the flow of the processing procedure goes on to the step S14 to produce a result of determination as to whether or not data of a predetermined amount has been stored in the read buffer 19. The determination process of this step is carried out repeatedly till data of the predetermined amount is stored in the read buffer 19. As the determination result produced at the step S14 indicates that data of the predetermined amount has been stored in the read buffer 19, the flow of the processing procedure goes on to a step S15 at which a process to decode the data stored in the read buffer 19 is started. Then, at the next step S16, a process to output a picture signal and a sound signal is started in order to begin a reproduction process.

Subsequently, the flow of the processing procedure goes on to the step S17 to produce a result of determination as to whether or not the content has been reproduced completely till the end. If the determination result produced at the step S17 indicates that the content has not been reproduced completely till the end, the flow of the processing procedure goes on to the step S18 to produce a result of determination as to whether or not data stored in the optical disk 15 mounted on the drive 14 has been read out completely till the end. If the determination result produced at the step S18 indicates that data stored in the optical disk 15 mounted on the drive 14 has not been read out completely till the end, the flow of the processing procedure goes back to the step S17 to repeat the determination process of this step.

If the determination result produced at the step S18 indicates that data stored in the optical disk 15 mounted on the drive 14 has been read out completely till the end, on the other hand, the flow of the processing procedure goes on to a step S19 at which the picker 18 restores the optical disk 15 mounted on the drive 14 to the disk slot 17 mentioned earlier.

Then, at the next step S20, the picker 18 conveys the next optical disk 15 from another disk slot 17 to the drive 14 and mounts the optical disk 15 on the drive 14. Subsequently, at the next step S21, a process to read out data from the optical disk 15 mounted on the drive 14 is started.

Then, at the next step S22, the data read out from the optical disk 15 is stored in the read buffer 19. Subsequently, the flow of the processing procedure goes on to the step S23 to produce a result of determination as to whether or not data of a predetermined amount has been stored in the read buffer 19. The determination process of this step is carried out repeatedly till data of the predetermined amount is stored in the read buffer 19. As the determination result produced at the step S23 indicates that data of the predetermined amount has been stored in the read buffer 19, the flow of the processing procedure goes on to a step S24 at which a process to decode the data stored in the read buffer 19 is started. Then, at the next step S25, a process to output a picture signal and a sound signal is started in order to begin a reproduction process. Subsequently, the flow of the processing procedure goes back to the step S17.

As the determination result produced at the step S17 indicates that the content has been reproduced completely till the end, the execution of the processing procedure is terminated.

As described above, the content reproduction process is suspended during a period in which an optical disk 15 mounted on the drive 14 is replaced with the next one, the next optical disk 15 is mounted on the drive 14 and a process to read out data from the next optical disk 15 is started. The length of the reproduction suspension period is dependent on the configuration of the mechanism of the picker 18. A typical value of the length is in the range 20 seconds to 30 seconds.

Since the reproduction process is suspended each time an optical disk 15 mounted on the drive 14 is replaced with the next one, the user experiences extremely big stress.

On the other hand, HSM (Hierarchical Storage Management) software is used. The HSM software is software for executing management to automatically move a file from a high-speed and high-price auxiliary recording apparatus such as a hard disk to a low-speed and a low-price recording medium. For more information on the HSM software, refer to Japanese Patent Laid-Open No. 2003-296151.

In the general HSM, the start portion of data is stored as a cache file on a hard disk used as a high-speed primary storage device. The entire data is stored in an optical disk serving as a low-speed secondary storage device. In an access made as an access to the data, while the start portion of the data cached in the primary storage device is being made, a remaining portion of the data is copied from the secondary storage device to the primary storage device. By carrying out such operations, the data appears to the user as if the entire data had been recorded in the primary storage device.

By storing the entire data in the secondary storage device having a low cost per recording unit and using the primary storage device as a cache memory, the user is lead to feel that the user were using a primary storage device that appears to the user as if the device were provided with a large storage capacity.

### SUMMARY OF THE INVENTION

Even if the HSM technique is adopted, however, it is not possible to prevent the suspension of the reproduction processing from occurring while an optical disk 15 mounted on the drive 14 is being replaced with the next one.

Addressing the problem described above, inventors of the present invention have devised a way to avoid suspension during a process to read out data of a content from recording mediums even if the content has a large amount of data.

In accordance with a first embodiment of the present invention, there is provided a recording apparatus including: a first recording medium configured to record a front portion included in the entire data of a content continuous along the time axis as a part of the content; a second recording medium configured to record a portion included in the entire data of the content as a part following the front portion recorded in the first recording medium.

The recording apparatus further includes: a third recording medium configured to record partial data of the content; and recording control means configured to control a process of recording data onto the third recording medium so as to record as much partial data of the content onto the third recording medium as data having a first data amount representing the amount of data, which can be read out from the third recording medium during a period to switch an operation to read out data from the first recording medium to the second recording medium.

As described above, the recording control means is capable of controlling a process of recording data onto the third recording medium so as to record as much partial data of the content onto the third recording medium, which can be read out from the third recording medium during a period to switch an operation to read out data from the first recording medium to the second recording medium.

The recording control means is capable of controlling a process of recording data onto the third recording medium on the basis of a second data amount representing the amount of data stored in the first recording medium but not stored in the third recording medium as data of the content and on the basis of the first data amount determined in accordance with a speed to read out data from the first recording medium.

The recording apparatus according to the first embodiment of the present invention further includes computation means configured to compute the first data amount. The recording control means is capable of controlling a process of recording data onto the third recording medium so as to record as much partial data of the content onto the third recording medium as data having the first data amount computed by the computation means.

When a reading apparatus for reading data of a content from the first, second or third recording medium reads out data of a content from the first or second recording medium, stores the data onto the third recording medium and reads out the data from the third recording medium, the recording control means is capable of controlling a process of recording data onto the third recording medium so as to record as much front partial data of the content onto the third recording medium as data having the first data amount.

The recording apparatus according to the first embodiment of the present invention further includes storage means configured to store information indicating whether or not each content data portion included in the data of the content recorded onto the second recording medium, which can be a data portion already recorded or not recorded yet on the third recording medium, is a data portion following data already recorded on the first recording medium.

In accordance with the first embodiment of the present invention, there is provided a recording method to be adopted by a recording apparatus including: a first recording medium configured to record a front portion included in the entire data of a content continuous along the time axis as a part of the content; a second recording medium configured to record a portion included in the entire data of the content as a part following the front portion recorded in the first recording medium; and a third recording medium configured to record partial data of the content.

The recording method includes the recording control step of controlling a process of recording data onto the third recording medium so as to record as much partial data of the content onto the third recording medium as data having a first data amount representing the amount of data, which can be read out from the third recording medium during a period to switch an operation to read out data from the first recording medium to the second recording medium.

In accordance with the first embodiment of the present invention, there is provided a program to be executed by a computer employed in a recording apparatus including: a first recording medium configured to record a front portion included in the entire data of a content continuous along the time axis as a part of the content; a second recording medium configured to record a portion included in the entire data of the content as a part following the front portion recorded in the first recording medium; and a third recording medium configured to record partial data of the content.

The program is executed by the computer to carry out the recording control step of controlling a process of recording data onto the third recording medium so as to record as much partial data of the content onto the third recording medium as data having a data amount representing the amount of data, which can be read out from the third recording medium during a period to switch an operation to read out data from the first recording medium to the second recording medium.

As described above, in accordance with the first embodiment of the present invention, a process of recording data onto the third recording medium is controlled so as to record as much partial data of the content onto the third recording medium as data having a data amount representing the amount of data, which can be read out from the third recording medium during a period to switch an operation to read out data from the first recording medium to the second recording medium.

In accordance with a second embodiment of the present invention, there is provided a reading apparatus including: a first recording medium configured to record a front portion included in the entire data of a content continuous along the time axis as a part of the content; a second recording medium configured to record a portion included in the entire data of the content as a part following the front portion recorded in the first recording medium.

The reading apparatus further includes: a third recording medium configured to record as much partial data of the content as data having a data amount representing the amount of data, which can be read out during a period to switch an operation to read out data from the first recording medium to the second recording medium; and reading control means configured to control a process of reading out data from the first, second or third recording medium so as to read out data of the content from the third recording medium during a period to switch an operation to read out data from the first recording medium to the second recording medium.

The reading control means is capable of controlling a process of reading out data so as to read out data of a content from the first or second recording medium, store the data onto the third recording medium and read out the data from the third recording medium.

The reading control means is capable of executing control to record data read out from the first or second recording mediums but not stored yet in advance on the third recording medium onto the third recording medium.

The reading control means is capable of controlling an operation to read out data from the first or second recording medium so as to read out data not recorded yet on the third recording medium from the first or second recording medium as data of a content.

The reading control means is capable of controlling an operation to read out data from the first or second recording medium so as to read out data at a high reading speed in comparison with ordinary read operations from the first or second recording medium.

In accordance with the second embodiment of the present invention, there is provided a reading method adopted in a reading apparatus including: a first recording medium configured to record a front portion included in the entire data of a content continuous along the time axis as a part of the content; a second recording medium configured to record a portion included in the entire data of the content as a part following the front portion recorded in the first recording medium; and a third recording medium configured to record as much partial data of the content as data having a data amount representing the amount of data, which can be read out during a period to switch an operation to read out data from the first recording medium to the second recording medium.

The reading method includes the step of controlling a process to read out data from the first, second or third recording medium so as to read out data of the content from the third recording medium during a period to switch an operation to read out data from the first recording medium to the second recording medium.

In accordance with the second embodiment of the present invention, there is provided a program to be executed by a computer employed in a reading apparatus including: a first recording medium configured to record a front portion included in the entire data of a content continuous along the time axis as a part of the content; a second recording medium configured to record a portion included in the entire data of the content as a part following the front portion recorded in the first recording medium; and a third recording medium configured to record as much partial data of the content as data having a data amount representing the amount of data, which can be read out during a period to switch an operation to read out data from the first recording medium to the second recording medium.

The program is executed by the computer to carry out the step of controlling a process to read out data from the first, second or third recording medium so as to read out data of the content from the third recording medium during a period to switch an operation to read out data from the first recording medium to the second recording medium.

In accordance with the second embodiment of the present invention, a process to read out data from the first, second or third recording medium is controlled so as to read out data of a content from the third recording medium during a period to switch an operation to read out data from the first recording medium to the second recording medium.

As described above, in accordance with the first embodiment of the present invention, the data of a content can be recorded.

In addition, in accordance with the first embodiment of the present invention, a reproduction process can be prevented from being suspended in the course of an operation to read out the data of a content.

As described above, in accordance with the second embodiment of the present invention, the data of a content can be read out.

In addition, in accordance with the second embodiment of the present invention, a reproduction process can be prevented from being suspended in the course of an operation to read out the data of a content.

### BRIEF DESCRIPTION OF THE DRAWINGS

FIG. 1 is a block diagram showing the configuration of the existing recording/reproduction system;

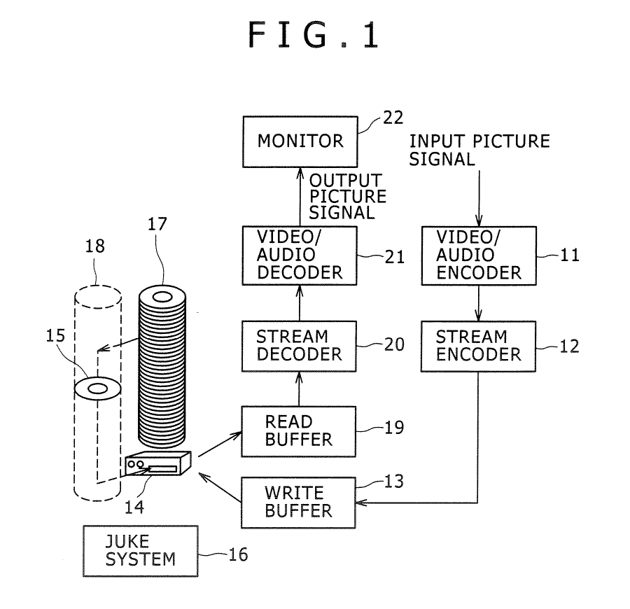

FIG. 2 is an explanatory diagram to be referred to in description of the existing recording method;

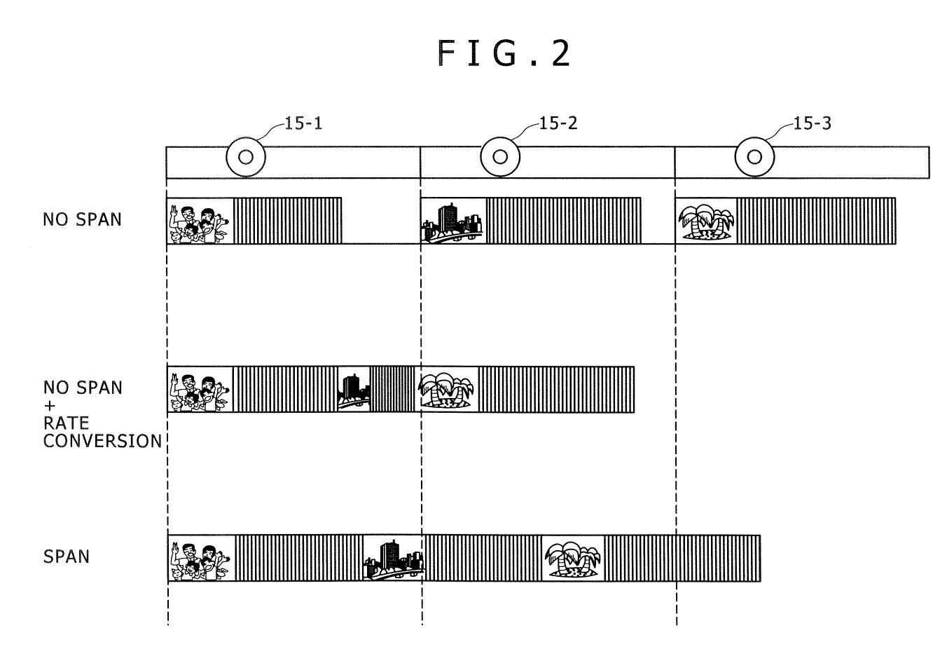

FIG. 3 shows a flowchart to be referred to in explanation of the existing processing to read out the data of a content recorded on optical disks;

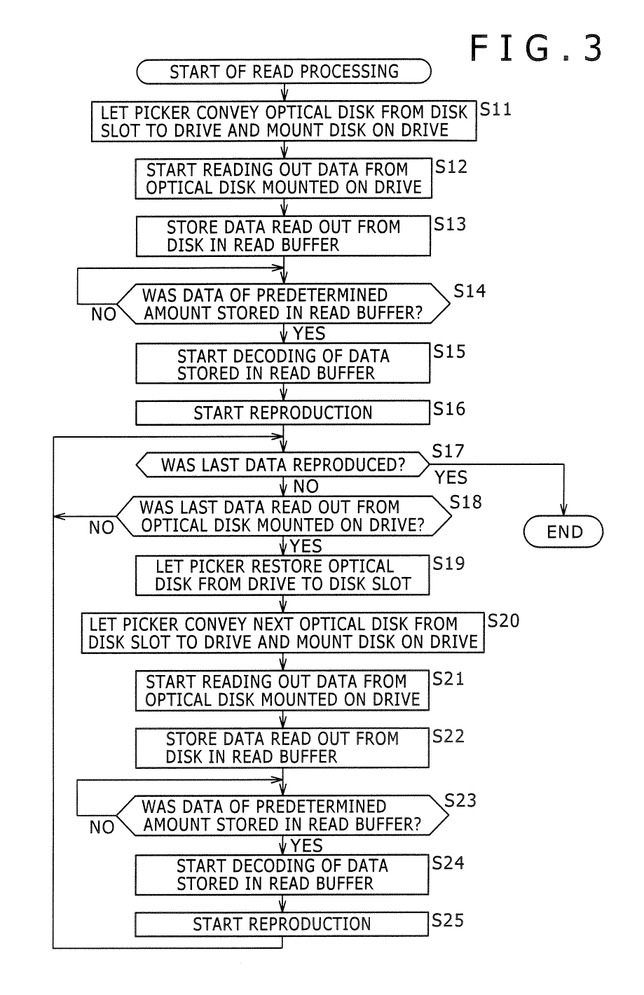

FIG. 4 is a block diagram showing the configuration of a recording/reproduction system according to an embodiment of the present invention;

FIG. 5 is a block diagram showing a more detailed configuration of the recording/reproduction system;

FIG. 6 is an explanatory diagram to be referred to in description of information used in the recording/reproduction system;

FIG. 7 is an explanatory diagram showing states of a cache file recorded on an HDD;

FIG. 8 is an explanatory diagram to be referred to in description of a cache file recorded on an HDD and an operation to read out data of a content by using the cache file;

FIG. 9 is an explanatory diagram to be referred to in description of an operation to read out data of a content by using the cache file;

FIG. 10 is an explanatory diagram showing areas and area information included in extension attributes;

FIG. 11 is an explanatory diagram to be referred to in description of a cache file in a stub state for a case in which the entire data of contents is recorded on a plurality of optical disks;

FIG. 12 is an explanatory diagram to be referred to in description of areas and area information included in extension attributes;

FIG. 13 is an explanatory diagram to be referred to in description of areas and area information included in extension attributes;

FIG. 14 is an explanatory diagram to be referred to in description of the amount of stub data stored in a stub area;

FIG. 15 is an explanatory diagram to be referred to in description of the amount of stub data stored in a stub area;

FIG. 16 is a diagram showing typical values of a data amount Dx;

FIG. 17 shows a flowchart to be referred to in explanation of processing carried out to write a content onto an optical disk;

FIG. 18 shows a flowchart to be referred to in explanation of processing to store hint information;

FIG. 19 shows a flowchart to be referred to in explanation of processing to generate a cache file in a stub file state;

FIG. 20 shows a flowchart to be referred to in explanation of processing to read out data of a content from index_n;

FIG. 21 shows a flowchart to be referred to in explanation of details of reloading processing;

FIG. 22 is an explanatory diagram showing positions of stub areas;

FIG. 23 is a diagram showing relations between the number of recordable contents and the length of each content for a no-span mode and a span mode;

FIG. 24 is a block diagram showing another configuration of the recording/reproduction system according to the embodiment of the present invention;

FIG. 25 shows a flowchart to be referred to in explanation of an operation to read out data of a content from a cache file;

FIG. 26 shows a flowchart to be referred to in explanation of processing to read out content data starting at index_n;

FIG. 27 shows a flowchart to be referred to in explanation of processing to replace an optical disk mounted on a drive with a next one;

FIG. 28 is a block diagram showing a further configuration of the recording/reproduction system according to the embodiment of the present invention; and

FIG. 29 is a block diagram showing a typical configuration of a personal computer.

### DETAILED DESCRIPTION OF THE PREFERRED EMBODIMENTS

Before preferred embodiments implementing details of the present invention are explained, relations between disclosed inventions and the embodiments are explained in the following comparative description, which verifies that the embodiments each described in detail in the explanation of the present invention for the purpose of supporting the present invention correspond to inventions. It is to be noted that, even if there is an embodiment described in detail in the explanation of the present invention but not included in the following comparative description as an embodiment corresponding to an invention, such an embodiment is not to be interpreted as an embodiment not corresponding to an invention. Conversely speaking, an embodiment included in the following comparative description as an embodiment corresponding to a specific invention is not to be interpreted as an embodiment not corresponding to an invention other than the specific invention.

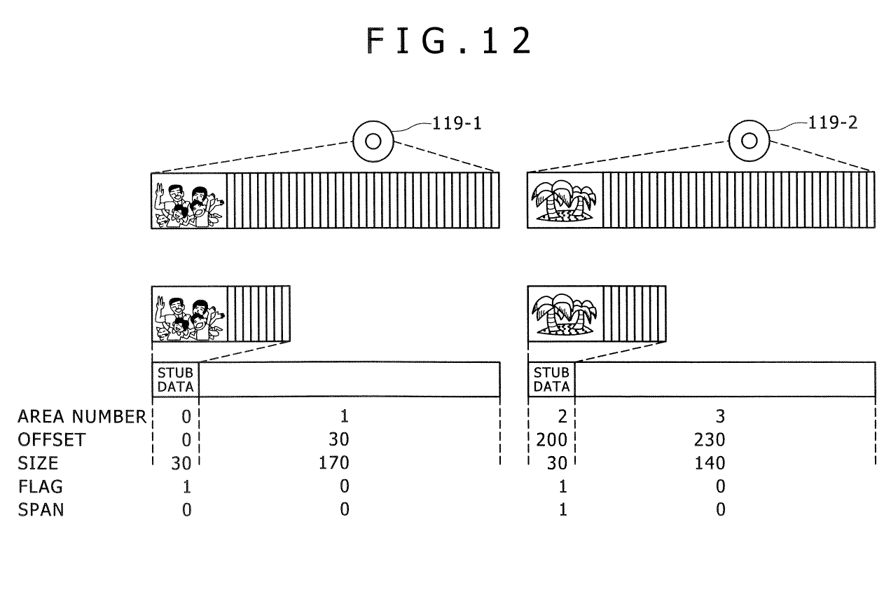

In accordance with a first embodiment of the present invention, there is provided a recording apparatus including: a first recording medium (such as an optical disk 119-1 shown in FIG. 12) used for recording a front portion included in the entire data of a content continuous along the time axis as a part of the content; a second recording medium (such as an optical disk 119-2 shown in FIG. 12) used for recording a portion included in the entire data of the content as a part following the front portion recorded in the first recording medium.

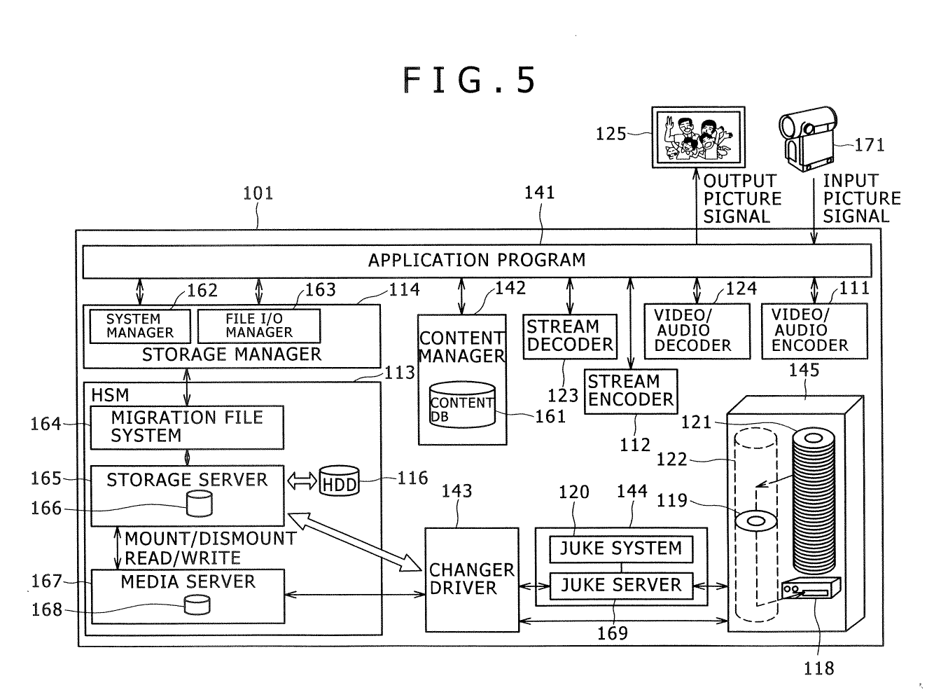

The recording apparatus further includes: a third recording medium (such as an HDD 116 shown in FIG. 5) used for recording partial data of the content; and recording control means (such as a storage manager 114 shown in FIG. 5) configured to control a process of recording data onto the third recording medium so as to record as much partial data (such as stub data shown in FIG. 12) of the content onto the third recording medium as data having a first amount representing the amount of data, which can be read out from the third recording medium during a period to switch an operation to read out data from the first recording medium to the second recording medium.

The recording apparatus according to the first embodiment of the present invention further includes computation means (such as a migration file system 164 shown in FIG. 5) configured to compute the first data amount. The recording control means is capable of controlling a process of recording data onto the third recording medium so as to record as much partial data of the content onto the third recording medium as data having the first amount computed by the computation means.

The recording apparatus according to the first embodiment of the present invention further includes storage means (such as a storage server 165 shown in FIG. 5) configured to store information (such as a span) indicating whether or not each content data portion included in the data of the content recorded onto the third recording medium, which can be a data portion already recorded or not recorded yet on the third recording medium, is a data portion following data already recorded on the first recording medium.

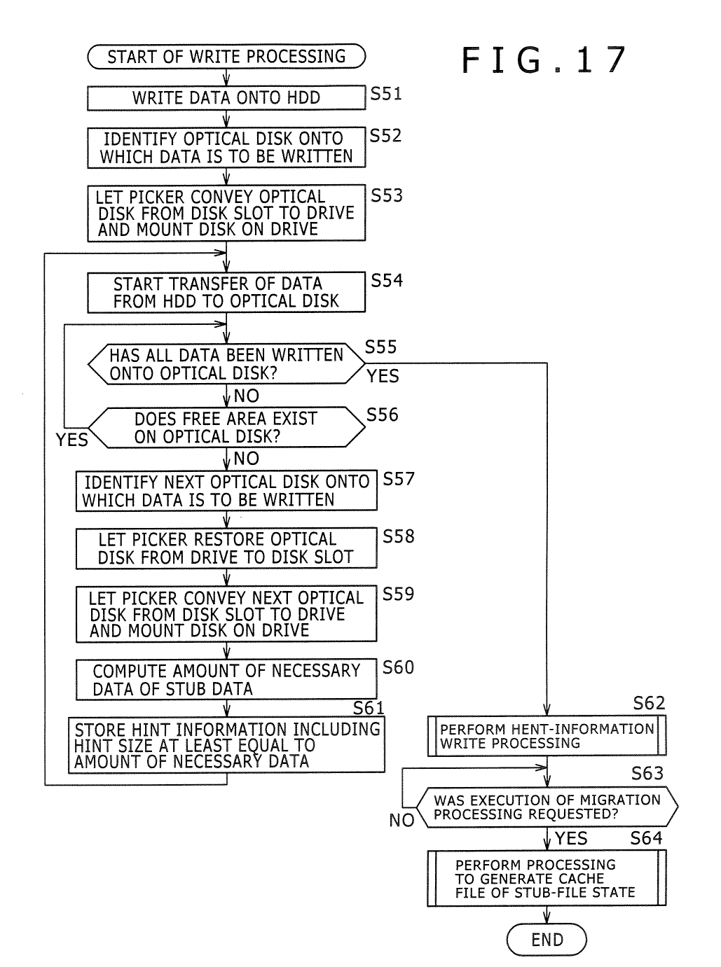

In accordance with the first embodiment of the present invention, there are provided a recording method and a program, which each include the recording control step (such as steps S54 and S64 of a flowchart shown in FIG. 17) of controlling a process of recording data onto the third recording medium (such as the HDD 116 shown in FIG. 5) so as to record as much partial data (such as the stub data shown in FIG. 12) of the content onto the third recording medium as data having a data amount representing the amount of data, which can be read out from the third recording medium during a period to switch an operation to read out data from the first recording medium (such as the optical disk 119-1 shown in FIG. 12) to the second recording medium (such as the optical disk 119-2 shown in FIG. 12).

In accordance with the second embodiment of the present invention, there is provided a reading apparatus including: a first recording medium (such as the optical disk 119-1 shown in FIG. 12) records a front portion included in the entire data of a content continuous along the time axis as a part of the content; a second recording medium (such as the optical disk 119-2 shown in FIG. 12) records a portion included in the entire data of the content as a part following the front portion recorded in the first recording medium.

The reading apparatus further includes: a third recording medium (such as the HDD 116 shown in FIG. 5) records as much partial data of the content as data having a amount representing the amount of data, which can be read out during a period to switch an operation to read out data from the first recording medium to the second recording medium; and reading control means (such as the storage manager 114 shown in FIG. 5) configured to control a process of reading out data from the first, second or third recording medium so as to read out data of the content from the third recording medium during a period to switch an operation to read out data from the first recording medium to the second recording medium.

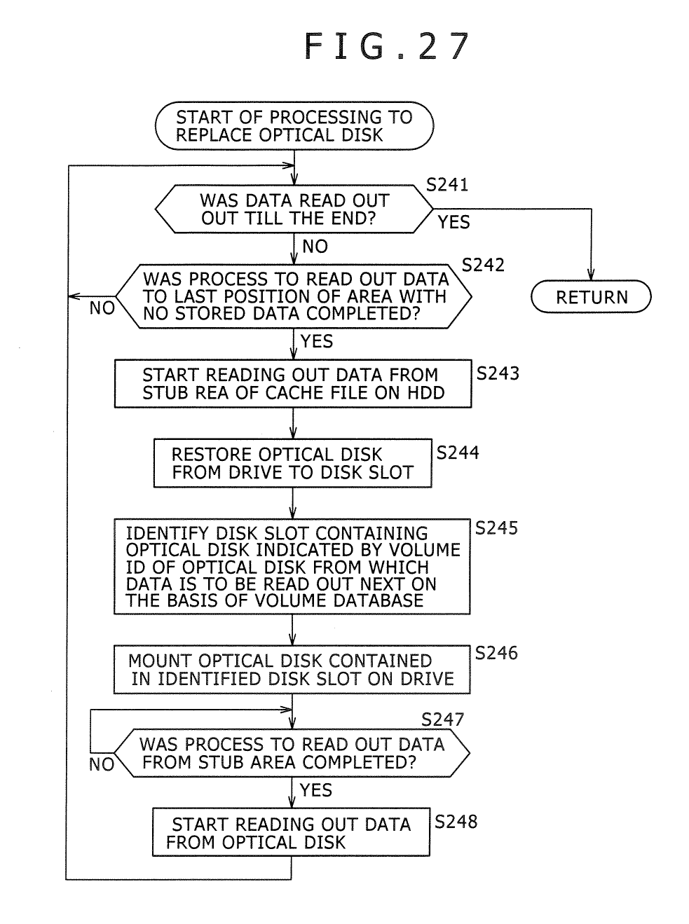

In accordance with the second embodiment of the present invention, there are provided a reading method and a program, which each include the reading control step (such as a step S243 of a flowchart shown in FIG. 27) of controlling a process to read out data from the first, second or third recording medium so as to read out data of the content from the third recording medium (such as the HDD 116 shown in FIG. 5) during a period (such as a period in which steps S244 to S246 of the flowchart shown in FIG. 27 are executed) to switch an operation to read out data from the first recording medium (such as the optical disk 119-1 shown in FIG. 12) to the second recording medium(such as the optical disk 119-2 shown in FIG. 12).

The present invention can be applied to a recording/reproduction system for recording the data of a content of pictures and sounds onto recording mediums and reproducing the recorded data from the recording mediums.

The following description explains a recording/reproduction system for recording the data of a content of pictures and sounds onto recording mediums and reproducing the recorded data from the recording mediums. It is needless to say, however, that the recording/reproduction system can also be configured as a recording system for only recording the data of a content of pictures and sounds onto recording mediums or a reproduction system for only reproducing the data of a content of pictures and sounds from the recording mediums.

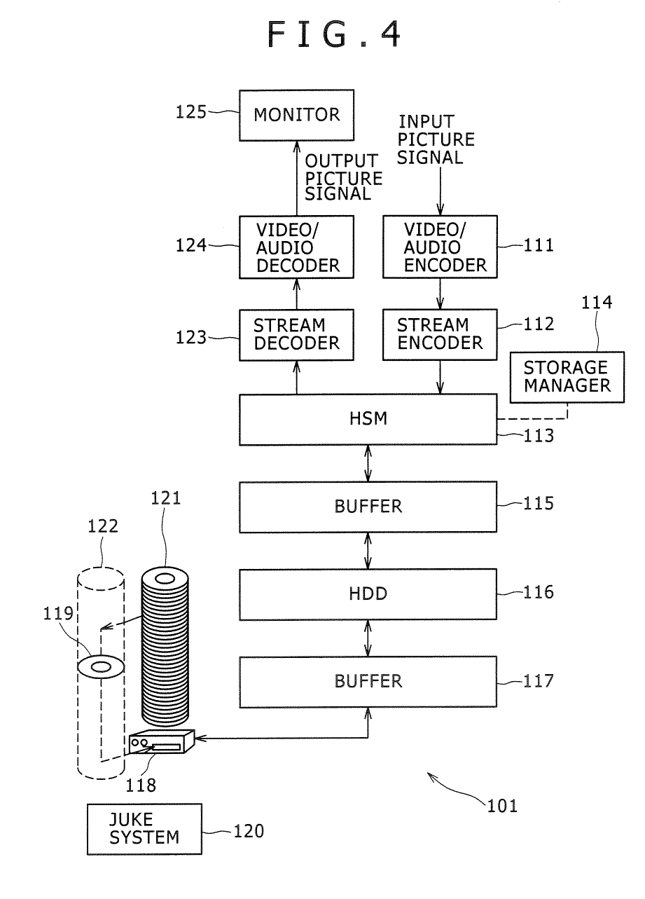

FIG. 4 is a block diagram showing the configuration of a recording/reproduction system 101 according to an embodiment of the present invention. As shown in the figure, the recording/reproduction system 101 includes a video/audio encoder 111, a stream encoder 112, an HSM apparatus 113, a storage manager 114, a buffer 115, an HDD (Hard Disk Drive) 116, another buffer 117, a drive 118, an optical disk 119, a juke system 120, disk slots 121, a picker 122, a stream decoder 123 and a video/audio decoder 124.

The video/audio encoder 111 is an apparatus for coding picture data of a base band corresponding to a received input picture signal by adoption of an MPEG method. In addition, the video/audio encoder 111 also encodes sound data of a base band corresponding to a received input sound signal not shown in the figure by adoption of the MPEG method. The video/audio encoder 111 supplies data obtained as a result of the coding process to the stream encoder 112.

The stream encoder 112 is an apparatus for multiplexing pieces of encoded data from the video/audio encoder 111 in order to convert the encoded data into a stream conforming to an MPEG transport stream system or an MPEG program stream system and supplying the stream obtained as a result of the conversion process to the HSM apparatus 113.

The HSM apparatus 113 is an apparatus for managing hierarchically layered operations to record the data of a content onto recording mediums, or the HSM apparatus 113 can be said to be an apparatus for managing operations to record the data of a content onto hierarchically layered recording mediums. Under control executed by the storage manager 114, the HSM apparatus 113 supplies a stream from the stream encoder 112 to the HDD 116 by way of the buffer 115. The HDD 116 is a typical high-speed primary storage device used for storing a data stream supplied by the HSM apparatus 113 by way of the buffer 115 in accordance with control executed by the HSM apparatus 113. The HDD 116 supplies a data stream stored therein to the buffer 115 or the buffer 117.

The buffer 115 is a semiconductor memory or the recording area of a portion of the HDD 116. The buffer 115 is a memory used for temporarily storing a data stream received from the HSM apparatus 113 or the HDD 116. The buffer 115 supplies a data stream stored temporarily therein to the HSM apparatus 113 or the HDD 116. By the same token, the buffer 117 is also a semiconductor memory or the recording area of a portion of the HDD 116. The buffer 117 is a memory used for temporarily storing a data stream received from the HDD 116 or the drive 118. The buffer 117 supplies a data stream stored temporarily therein to the HDD 116 or the drive 118.

The buffers 115 and 117 absorb read jitters to average the flow of data by making the data rate constant.

The drive 118 is an apparatus for storing data received from the buffer 117 onto an optical disk 119 mounted on the drive 118 as a data file. The optical disk 119 is a typical low-speed secondary storage device. Examples of the optical disk 119 are an MO (Magnetic-Optical) disk, a DVD (Digital Versatile Disk) and a CD (Compact Disk).

The juke system 120 is a system for controlling operations to mount an optical disk 119 onto the drive 118 and dismount the optical disk 119 from the drive 118. To put it in detail, the juke system 120 drives the picker 122 to select one of a plurality of optical disks 119 each accommodated in a disk slot 121. On the basis of control executed by the juke system 120, the picker 122 conveys the selected optical disk 119 to the driver 118 and mounts the conveyed optical disk 119 onto the drive 118. Also on the basis of control executed by the juke system 120, the picker 122 dismounts an optical disk 119 from the drive 118, conveys the dismounted optical disk 119 to the disk slots 121 and puts the conveyed optical disk 119 in one of the disk slots 121. In this way, the juke system 120 controls the picker 122.

In addition, the drive 118 also reads out data stored as a file on an optical disk 119 mounted thereon and supplies the data read out from the optical disk 119 to the buffer 117. In actuality, the data read out from the optical disk 119 is supplied to the HDD 116 by way of the buffer 117 to be stored on the HDD 116.

The HSM apparatus 113 reads out a data stream from the HDD 116 through the buffer 115. The data stream is a stream read out from an optical disk 119 and recorded on the HDD 116. The HSM apparatus 113 supplies the data stream read out from the HDD 116 to the stream decoder 123.

The stream decoder 123 is an apparatus for splitting the data stream conforming to the MPEG transport stream system or the MPEG program stream system into picture data and sound data and supplying the picture data and the sound data separated from each other to the video/audio decoder 124.

The video/audio decoder 124 is an apparatus for decoding coded picture data and coded sound data into the so-called base-band picture data and base-band sound data respectively. The video/audio decoder 124 supplies an output picture signal based on the base-band picture data obtained as a result of the decoding process and an output sound signal not shown based on the base-band sound data also obtained as a result of the decoding process to the monitor 125. The monitor 125 is an apparatus for displaying a picture based on the picture signal received from the video/audio decoder 124 and outputting a sound based on the picture signal also received from the video/audio decoder 124.

As described above, the video/audio encoder 111 encodes the data of a content represented by a received input picture signal as a content to be recorded onto the HDD 116. In this case, all the data of the content is recorded onto the HDD 116. Then, predetermined data of the content recorded on the HDD 16 is all copied to an optical disk 119 mounted on the drive 118 during an available period of the drive 118. With regard to such copy operations, the HSM apparatus 113 stores information in a store database to be described later as information on optical disks 119 each used for storing predetermined data of the content. As will be described later in detail, this information stored in the store database includes the ID of a file used for storing the predetermined data of the content or the name of the file, IDs of optical disks 19 used for recording all the data of the content and a recording date/time of the content.

It is to be noted that the recording/reproduction system 101 is also capable of recording a stream received directly from an external source and outputting a stream to an external recipient. In addition, the data encoding method is not limited to the MPEG technique. Any encoding method can be adopted as long as the method can be used for carrying out predetermined compression and decompression processes. In addition, the stream method does not impose limitations on the present invention.

FIG. 5 is a block diagram showing a more detailed configuration of the recording/reproduction system 101. As shown in the figure, the recording/reproduction system 101 includes a content manager 142, a changer driver 143 and a juke-box control section 144. In the more detailed configuration of the recording/reproduction system 101, a CPU (Central Processing Unit) not shown in the figure executes an application program 141.

The application program 141 has a function to interface with the user. To be more specific, the interface function receives a command from the user and informs the user of various kinds of information on the recording/reproduction system 101. The application program 141 is basically a program for controlling the whole of the recording/reproduction system 101.

To be more specific, the application program 141 typically controls the video/audio encoder 111, the stream encoder 112, the video/audio decoder 124, the stream decoder 123, the content manager 142 and the storage manager 114. The application program 141 receives an input picture signal and an input sound signal from a video camera 171, supplying the received input picture signal and the received input sound signal to the video/audio encoder 111. In addition, the application program 141 receives an output picture signal and an output sound signal from the video/audio decoder 124, supplying the received output picture signal and the received output sound signal to the monitor 125. On top of that, the application program 141 requests the storage manager 114 to control an operation to supply a data stream received from the HSM apparatus 113 to the stream decoder 123.

The content manager 142 is an apparatus for managing data of contents recorded in the recording/reproduction system 101 and searching the contents for a desired one. The content manager 142 controls operations to record various kinds of information on contents into a content database (DB) 161 and read out information on a content from the content database 161.

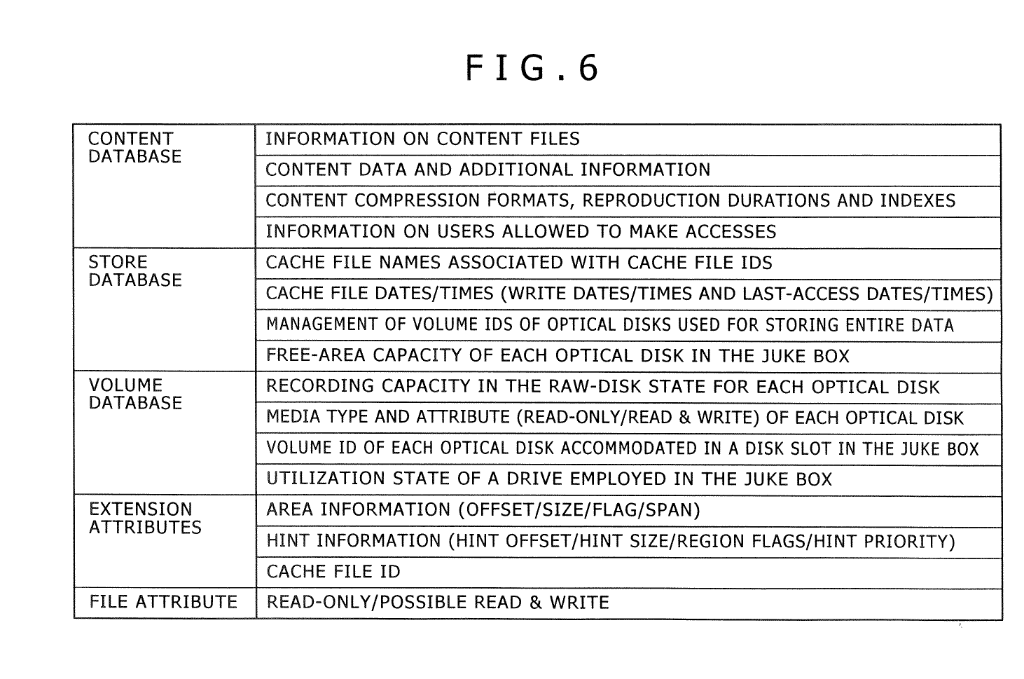

As shown in FIG. 6, information stored in the content database 161 as information on a content includes information on a file relevant to the content, the substance of the content, additional information attached to the content, the compression format (or the compression system) of the content, the reproduction duration of the content, index information of the content and information on users each allowed to make an access to the content. The information on a file relevant to a content includes the name of the file and the path name of the file. The additional information attached to a content includes the title and genre of the content. The index information of a content includes the position of an index in the content. The information on users each allowed to make an access to a content includes the name of each of the users and a password assigned to each of the users.

The storage manager 114 is an apparatus for controlling the HSM apparatus 113 from an upper level. That is to say, the storage manager 114 controls the HSM apparatus 113 on the basis of a request made by the application program 141. The storage manager 114 is provided with a system manager 162 and a file I/O manager 163.

The system manager 162 is a section for setting a system related to storage control, operations to record data onto a system log, management of a log of errors and execution of maintenance operations. On the other hand, the file I/O manager 163 is a section for receiving a request for a file read operation and a request for a file write operation from the application program 141. The file I/O manager 163 makes a request for a process of converting the file of a content recorded on the HDD 116 into a stub file (or a stub-state file) for holding specified partial data of the content as stub data. The specified partial data is typically a portion of a video or musical content. The file I/O manager 163 also makes a request for suspension or resumption of a process to read out data from an optical disk 119 and transfer the data to the HDD 116. In the following description, the process to read out data from an optical disk 119 and transfer the data to the HDD 116 is also referred to as a reloading process. In addition, the file I/O manager 163 also makes a request for suspension or resumption of a process to read out data from the HDD 116 and write the data onto an optical disk 119.

The HSM apparatus 113 controls an operation to temporarily store the data of a content onto the HDD 116 by treating the HDD 116, the drive 118, the optical disk 119, the juke system 120, the disk slot 121 and the picker 122 as a virtual storage device. The HSM apparatus 113 is configured to include a migration file system 164, the aforementioned storage server 165, the aforementioned store database (DB) 166, a media server 167 and a volume database (DB) 168.

A migration file system 164 is a section for managing and rewriting extension attributes of files managed by the HSM apparatus 113. The migration file system 164 also manages events of accesses to files managed by the HSM apparatus 113. In addition, the migration file system 164 controls a process to read out data from an optical disk 119 and transfer the data to the HDD 116 and a process to read out data from the HDD 116 and write the data onto an optical disk 119.

The storage server 165 is a server for reading out data from an optical disk 119 to be transferred to the HDD 116 and reading out data from the HDD 116 to be written onto an optical disk 119. The storage server 165 also manages a process to record information on a cache file stored in the HDD 116 as a file used for storing the data of a content onto the store database 166 and a process to read out the information on a cache file from the store database 166. In addition, the storage server 165 also manages the entire data of each content and information on a link to an optical disk 119 used for recording the data.

The store database 166 is a database used for storing information on each cache file stored in the HDD 116 as a file used for storing the data of a content.

As shown in FIG. 6, the store database 166 is used for storing cache file names and cache file IDs by associating each of the cache file names with one of the cache file IDs. A cache file name is the name of a cache file stored in the HDD 116 and a cache file ID associated with the cache file name is a value (or an identification number) used for identifying the cache file. In addition, for every cache file, the store database 166 is also used for storing a cache file date/time. The cache file date/time is a date/time at which data was written into the cache file or a date/time at which the cache file was accessed last. The store database 166 is also used for storing a volume ID (or a volume identification code) used for identifying each of optical disks 119 used for recording the entire data of a content. In addition, the store database 166 is also used for recording the size of a free area available in every optical disk 119 accommodated in a juke box 145.

To put it in more detail, the information stored in the store database 166 as the information on a cache file includes a cache file ID, a file size, a write date/time, a cache file name and a cache file path. The file size of a cache file is a quantity expressed in terms of typically bytes as the amount of data stored in the cache file. The cache-file path is positional information on a position at which the cache file has been recorded on the HDD 116.

In addition, for each content, the information stored in the store database 166 as the information on a cache file includes the number of optical disks 119 on which the entire data of the content has been recorded (or preserved), a volume ID assigned to each of optical disks 119 used for recording the entire data of the content and an offset and size of data recorded in each of the optical disks 119. If the entire data of a content is recorded on a plurality of optical disks 119 by being spread over the optical disks 119, that is, if the entire data of a content is recorded on a plurality of optical disks 119 by being divided into portions each stored in one of the optical disks 119, the number of optical disks 119 is two or greater.

If the number of optical disks 119 used for recording the data of one content is at least two, the information on the cache file used for storing the content includes as many volume IDs, start positions of pieces of data stored in the optical disks 119 and sizes of pieces of data stored in the optical disks 119 as the optical disks 119. In this case, each of the volume IDs is used for identifying one of the optical disks 119 used for recording the entire data of the content by splitting the data into pieces of data spread over the optical disks 119. An offset of a piece of data stored in any specific one of the optical disks 119 is the distance between the head of the specific optical disk 119 and the start position of the piece of data. The offset is a value expressed typically in terms of bytes. Also expressed typically in terms of bytes, the size of a piece of data stored in any specific one of the optical disks 119 is the amount of the piece of data stored in the specific optical disk 119 as data of the content.

The media server 167 is a server for managing optical disks 119 each accommodated in a disk slot 121. The media server 167 requests the changer driver 143 to mount a specified optical disk 119 accommodated in a disk slot 121 onto the drive 118. The media server 167 also requests the changer driver 143 to dismount an optical disk 119 from the drive 118 and restores the optical disk 119 to its disk slot 121.

The volume database 168 provided in the media server 167 is used for storing information related to optical disks 119.

As shown in FIG. 6, the information stored in the volume database 168 includes a recording capacity in the raw-disk state of each optical disk 119 and the type and attribute of each optical disk 119. The attributes include the media type of the optical disk 119. The media type of an optical disk 119 typically indicates that the optical disk 119 is an MO (Magnetic-Optical) disk, a DVD (Digital Versatile Disc) +R or a DVD+RW. The attribute of an optical disk 119 typically indicates whether the optical disk 119 is a read-only disk or a read/write disk, which is a disk allowing data to be read out from it and written thereon. In addition, the volume database 168 also includes the volume ID of an optical disk 119 accommodated in each disk slot 121 of the juke box 145 and the state of utilization of the drive 118 employed in the juke box 145.

The changer driver 143 is an apparatus functioning as an interface between the juke-box control section 144 and the HSM 113 by controlling the drive 118.

The juke-box control section 144 includes the aforementioned juke system 120 and a juke servo 169. The juke system 120 is a section for controlling a system including the drive 118, the optical disks 119, the disk slots 121 and the picker 122. The juke servo 169 is a server for driving the juke box 145.

The juke box 145 is the system including the drive 118, the optical disks 119, the disk slots 121 and the picker 122.

It is to be noted that the data stored in the content database 161, the store database 166 and the volume database 168 can also be stored collectively in a single database.

In addition, as shown in FIG. 6, extension attributes stored in a migration file system 164 as attributes of a content include area information for partial data stored in a cache file as a portion of the content, hint information used as a hint as to which portion of the content has been stored in the HDD 116 as a cache file and a cache file ID.

Note that it is possible to provide a configuration in which the file system of the OS records and reads out the extension attributes of a content. In addition, the extension attributes of a content can also be recorded in the content database 161.

To put it in more detail, the area information is information provided for a data portion stored in a cache file as a portion of a content. The area information includes an offset expressed in terms of bytes, the size of the data portion of the content, a flag and a span. The offset is the distance between the head of the data of the content and the head of the data portion of the content. As will be described later in detail, the flag indicates whether the data portion of the content is in a state of being already stored or a state of being held and, on the other hand, the span is a flag indicating whether or not the data portion of the content and the immediately preceding data portion of the same content are data portions recorded on the same optical disk 119. The hint information is information indicating which data portion of the content is to be recorded on the HDD 116 as a cache file. The hint information includes a hint offset, a hint size, region flags and a hint priority. Expressed in terms of bytes, the hint offset is an offset value representing the distance between the head of the data of the content and the head of the indicated data portion of the content. The hint size is the size of the indicated data portion. The region flags are each an attribute of the data portion. The hint priority is a priority level at which the data portion is migrated if migration is required.

In addition, as shown in FIG. 6, a file system records the attribute of a file used for storing data of a content. The attribute of a file indicates that the file is a read-only file or a read/write file, which is a file allowing data to be read out from it and written thereon.

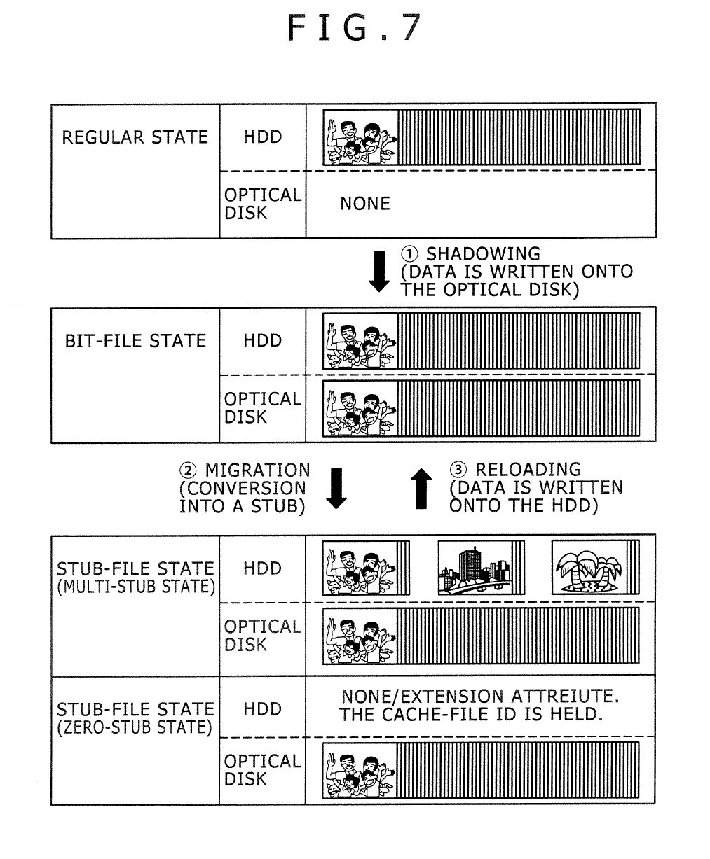

By referring to FIGS. 7 to 10, the following description explains a cache file recorded in the HDD 116 and an operation to read out data of a content by using the cache file.

FIG. 7 is an explanatory diagram showing states of a cache file recorded in the HDD 116. A content stream obtained as a result of a coding process carried out by the video/audio encoder 111 and a multiplexing process carried out by the stream encoder 112 is written into a cache area of the HDD 116 as a cache file. As shown in FIG. 7, the state of a cache file in which the entire data of a predetermined input content stream is recorded is referred to as a regular state.

A shadowing process is a process to write a cache file already recorded in the HDD 116 in a regular state onto an optical disk 119 during a free time of the juke box 145. By carrying out a shadowing process, the entire data of a predetermined content can be recorded on not only the HDD 116, but also an optical disk 119. The state of a cache file recoded on both the HDD 116 and an optical disk 119 as a file used for storing the entire data of a predetermined content is referred to as a bit file state.

It is to be noted that, when a shadowing process is carried out to record a cache file onto an optical disk 119, information on the cache file is also recorded into the store database 166. The information on the cache file includes the name of the cache file, the ID assigned to the cache file and the size of the cache file.

A cache file in a regular or bit file state can be said to be a cache file recorded at least in the HDD 116 as a file used for storing the entire data of a content or the entire data of a stream. In this case, since the entire data of the content can be read out from the HDD 116, the process to read out the data can be carried out at a high speed. In the case of many contents, however, the amount of data stored in a cache file is large. Thus, in order to record a cache file in the HDD 116 in a regular or bit file state, a large storage area of the HDD 116 is consumed, putting the HDD 116 in a fully occupied state soon. That is to say, the HDD 116 is soon put in a state in which the entire recording area included in the HDD 116 as an area used for recording data is exhausted.

In order to solve the problem described above, cache files each used for storing partial data of a content are sequentially copied from the HDD 116 to an optical disk 119 with the lapse of time in an order starting with a cache file recorded in the HDD 116 as an earliest file along the time axis in order to record the entire data of the content. In this way, the amount of data stored in cache files recorded in the HDD 116 can be reduced. To be more specific, the total amount of data stored in cache files recorded in the HDD 116 can be limited to a quantity in a predetermined range.

As shown in FIG. 7, the entire data of a certain content has not been all recorded, however, a predetermined partial data of the content has been stored in a cache file. The state of such a cache file is referred to as a stub file state. In particular, the state of cache files each used for storing partial data of a content, the entire data of which has not been recorded on an optical disk 119, is referred to as a multi-stub state. A zero-stub state is a state in which the whole data of a content stored in the HDD 116 as cache files has been transferred from the HDD 116 to an optical disk 119 except the extension attributes of the content and the ID of each of the cache files.

A reloading process is an operation to read out predetermined partial data of a content from an optical disk 119 used for recording the entire data of the disk and record the partial data onto the HDD 116. In particular, a reloading process can be carried out to read out the entire data of a content from an optical disk 119 used for recording the data of the content and record the data onto the HDD 116.

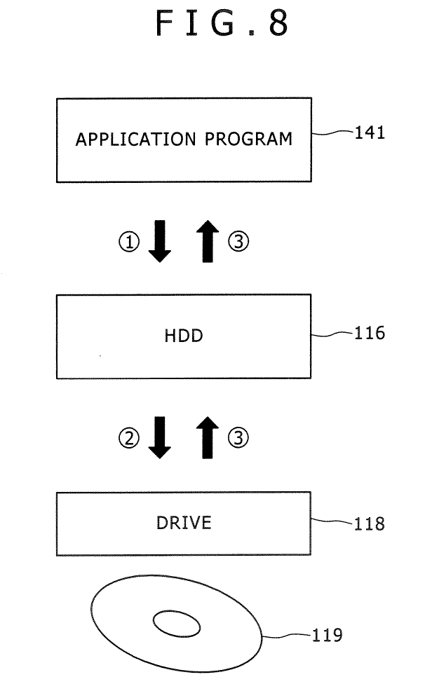

As shown in FIG. 8, data corresponding to input picture and sound signals received from an application program 141 is recorded onto the HDD 116 and the data recorded in the HDD 116 is further recorded on an optical disk 119 mounted on the drive 118. In an operation to read out the data, the data is read out from the HDD 116 or from the optical disk 119 through the drive 118. If the data is read out from the optical disk 119 through the drive 118, the data is temporarily recorded in the HDD 116 before eventually being read out by the application program 141 from the HDD 116.

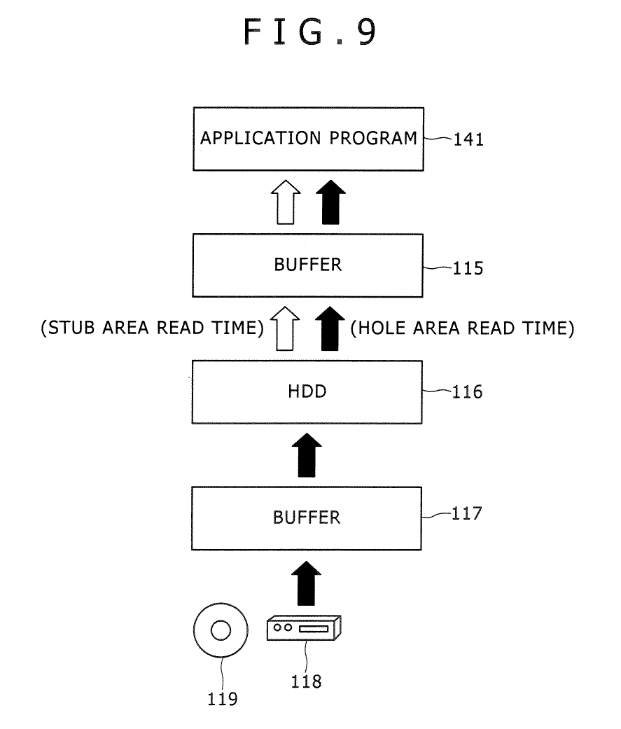

To put it more concretely, the above data read operation is described by referring to FIG. 9 as follows. First of all, the drive 118 reads out data from the optical disk 119 mounted on the drive 118 and stores the data in the buffer 117 temporarily. Then, the data stored in the buffer 117 temporarily is supplied to the HDD 116 to be recorded in the HDD 116.

In the mean time, data already recorded in advance in a stub area of the HDD 116 is transferred to the buffer 115 to be stored in the buffer 115 temporarily. The stub area will be described later. In the same way, in accordance with a request for an operation to read out data, the data is read out from the optical disk 119 through the buffer 117, and data recorded before in a hole area of the HDD 116 is also transferred to the buffer 115 to be stored in the buffer 115 temporarily. The hole area will also be described later.

The application program 141 reads out the data stored in the buffer 115 temporarily from the buffer 115, generating output picture and sound signals.

A cache file recorded in the HDD 116 in a bit-file state is used for storing the entire data of a file. On the other hand, a cache file recorded in the HDD 116 in a stub state is used for storing partial data of a file.

The reproduction duration of stub data of a content being reproduced is greater than the length of time it takes to bring out an optical disk 119 from a disk slot 121 used for accommodating the optical disk 119, convey the optical disk 119 from the disk slot 121 to the drive 118, mount the optical disk 119 onto the drive 118 and read out data of the content from the optical disk 119 mounted on the drive 118. The reproduction duration of stub data of a content being reproduced has a length in the range 20 to 30 seconds.

A stub is defined as a content portion corresponding to data recorded in a cache area of the HDD 116. A stub area is the area of a stub of a content. A stub area is thus an area included in the HDD 116 as an area used for storing the stub. On the other hand, a hole area is an area included in the HDD 116 as an area in which no content data has been stored.

A technical term ‘area’ is used in the following description to represent a cache or hole area when it is not necessary to distinguish the cache and hole areas from each other.

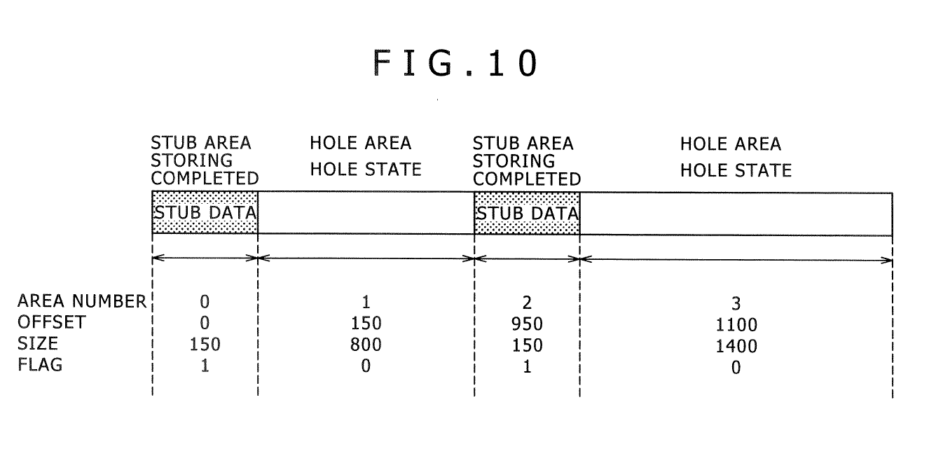

Next, areas and area information included in the extension attributes are explained by referring to FIG. 10. In an example shown in FIG. 10, a first stub area shown at the left top corner in the figure is allocated to the head of the data of a content whereas a first hole area is allocated to data following the head. The first hole area is followed by a second stub area, which is followed by a second hole area. The first stub area is in an already-stored state. The already-stored state of an area is a state in which partial data of the content has been stored in the area. In other words, in the case of the first stub area, the partial data at the head of the content has been stored in the area in a cache file recorded in the HDD 116. However, partial data having a predetermined length immediately follows the partial data at the head of the content, but has not been recorded in the cache file of the HDD 116, forming the first hole area in the so-called hole state. Other stub data having a predetermined length immediately follows the first hole area and has been recorded in the cache file of the HDD 116, forming the second stub area in an already-stored state. However, partial data having a predetermined length immediately follows the second stub area, but has not been recorded in the cache file of the HDD 116, forming the second hole area in a hole state. That is to say, stub areas each used for storing partial data of the content in the cache file in the HDD and hole areas each used for storing no partial data of the content in the cache file in the HDD are laid out in the HDD 116 alternately, being allocated to pieces of partial data of the content.

The area information of every area includes an area number assigned to the area, an offset of the area, the size of the area and a flag of the area. The area number is one of smoothly increasing integers in the range zero to N with the integer zero assigned to the first area in the file. That is to say, area numbers beginning with an initial integer of zero are assigned sequentially to areas as sequence numbers in an order starting with the area corresponding to the head of the data of the content. The offset of an area is the distance between the head of the area and the head of the file including the area or the head of the data of the file. The offset is expressed typically in terms of bytes. The size of an area is the amount of data stored in the area. The size is also expressed typically in terms of bytes. The flag of an area is information indicating whether the area is a stub area in an already-stored state or a hole area in a hole state. Typically, a flag set at one indicates that the area is a stub area in an already-stored state whereas a flag set at one indicates that the area is a hole area in a hole state.

For example, the stub area used for storing the head of the data of a content is put in an already-stored state at a position coinciding with the head of the data of the content as an area with a size of 150 bytes indicating the amount of the head of the data included in the content. Thus, in this case, the information of the area includes an area number of zero, an area offset of zero, an area size of 150 and an area flag of one. Let us assume as another example that a second area from the head of the data of the content is a hole area in a hole state and has a size of 800 bytes representing the amount of original data in this area. In this case, the information of the area includes an area number of one, an area offset of 150, an area size of 800 and an area flag of zero.

By the same token, since a third area from the head of the data of the content is a stub area in an already-stored state and has a size of 150 bytes representing the amount of data already stored in this area, the information of the area includes an area number of two, an area offset of 950 (=800+150), an area size of 150 and an area flag of one. In the same way, since a fourth area from the head of the data of the content is a hole area in a hole state and has a size of 1,400 bytes representing the amount of original data in this area, the information of the area includes an area number of three, an area offset of 1,100 (=950+150), an area size of 1,400 and an area flag of zero.

As described above, area information included in the extension attributes of a content as area information of each area shows the state of the area. Thus, by referring the area information of an area, the state of the area in the cache file can be recognized.

The following description explains a case in which the entire data of a plurality of content is recorded on a plurality of optical disks 119, by being spread over the optical disks 119.

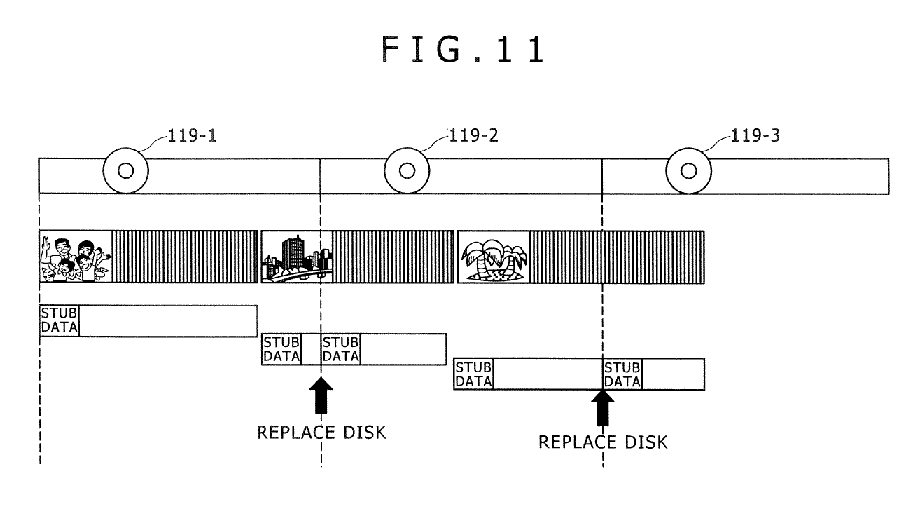

FIG. 11 is an explanatory diagram to be referred to in description of a cache file in a stub state for a case in which the entire data of three contents is recorded on three optical disks 119-1 to 119-3 by being spread over the optical disks 119-1 to 119-3. To put it in detail, the entire data of the first content has been recorded at the head of the recording area of the optical disk 119-1. The cache file of the first content is put in a stub state and a stub area is placed at the head of the first content. That is to say, data at the head of the first content has been recorded in the cache file as stub data.

The earlier part of the entire data of the second content is recorded on the optical disk 119-1, following the data of the first content. On the other hand, a part following the earlier part on the optical disk 119-1 as the later part of the entire data of the second content has been recorded at the head of the recording area of the optical disk 119-2. The cache file of the second content is put in a stub state and a stub area is placed at the head of the second content. In addition, another stub area is also put at the head of a content corresponding to the data of a content recorded on the optical disk 119-2. That is to say, the head of data recorded on the optical disk 119-2 as the later part of the second content has been recorded in a cache file as stub data.

The earlier part of the entire data of the third content is recorded on the optical disk 119-2, following the data of the second content. On the other hand, a part following the earlier part on the optical disk 119-2 as the later part of the entire data of the third content has been recorded at the head of the recording area of the optical disk 119-3. The cache file of the third content is put in a stub state and a stub area is placed at the head of the third content. In addition, another stub area is also put at the head of a content corresponding to the data of a content recorded on the optical disk 119-3. That is to say, the head of data recorded on the optical disk 119-3 as the later part of the third content has been recorded in a cache file as stub data.

As described above, if the entire data of a content is recorded on a plurality of optical disks 119 by being spread over the optical disks 119, an area for content data recorded in the vicinity of a boundary between the recording areas of two optical disks 119 is used as a stub area. That is to say, content data existing in the vicinity of a boundary between the recording areas of two optical disks 119 is recorded as stub data in a cache file in the HDD 116.

By recording content data of the vicinity of a boundary between the recording areas of two optical disks 119 as stub data in a cache file in the HDD 116 as described above, the stub data can be read out data from the HDD 116 without exhausting the HDD 116 while an optical disk 119 mounted on the drive 118 is being changed to another optical disk 119 in an operation to replace the optical disk 119 mounted on the drive 118 with the other optical disk 119. Thus, the data of a content can be supplied to the application program 141 without interrupting the operation to read out the data of the content from optical disks 119. As a result, the content can be reproduced without being interrupted.

By referring to FIG. 12, the following description explains a case in which the entire data of a content is recorded on a plurality of optical disks 119 by being spread over the optical disks 119.

The area information of an area includes a span indicating whether or not content data of the area has been recorded on the same optical disk 119 as content data immediately preceding the content data of the area. In other words, a span of an area indicates whether or not the immediately preceding content data has been recorded on an optical disk 119 different from an optical disk 119 on which the content data of the area has been recorded.

A zero span of an area indicates that content data of the area has been recorded on the same optical disk 119 as content data immediately preceding the content data of the area. In other words, a zero span of an area indicates that the immediately preceding content data has been recorded on the same optical disk 119 as the content data of the area. On the other hand, a one span of an area indicates that content data of the area has been recorded on an optical disk 119 different from an optical disk 119 on which content data immediately preceding the content data of the area has been recorded. In other words, a one span of an area indicates that the immediately preceding content data has been recorded on an optical disk 119 different from an optical disk 119 on which the content data of the area has been recorded.

In an example shown in FIG. 12, the data of the earlier part of a content has been recorded on the optical disk 119-1. On the other hand, content data immediately following the data recorded on the optical disk 119-1 as the data of the earlier part of the content has been recorded on the optical disk 119-2.

In the example shown in FIG. 12, a head portion included in a content area for the content data recorded on the optical disk 119-1 as a portion having a predetermined length is set as a stub area while the remaining portion following the head portion in the content area is set as a hole area. That is to say, the data of the head portion in the data recorded in the recording area of the optical disk 119-1 has been recorded in a cache file as stub data and data following the head portion is not stored in the cache file. By the same token, a head portion included in a content area for the content data recorded on the optical disk 119-2 as a portion having a predetermined length is set as a stub area while the remaining portion following the head portion in the content area is set as a hole area.

The stub area of the content area for the content data recorded on the optical disk 119-1 is placed at the head of the content and the amount of data stored in the stub area is 30 bytes. Thus, the area information of this stub area includes an area number of zero, an area offset of zero, an area size of 30 and an area flag of one. Since the stub area is an area placed at the head of the content, the span of the area is set at zero, which is a span value assigned to all head areas.

The data of the hole area set on the optical disk 119-1 as the later part of the content area for the data of the content recorded on the optical disk 119-1 has been recorded on the same optical disk 119-1 as the data of the stub area immediately preceding this hole area, which is the second area from the head of the content. In addition, since the size of the original data of this hole area is 170 bytes, the area information of this hole area includes an area number of one, an area offset of 30, an area size of 170, an area flag of zero and an area span of zero.

The data of the stub area of the content area for the content data recorded on the optical disk 119-2 has been recorded on the optical disk 119-2 while, as described above, the data of the hole area having the area number of one has been recorded on the optical disk 119-1. The stub area of the content area for the content data recorded on the optical disk 119-2 is the third area in the content and the amount of data stored in this stub area is 30 bytes. Thus, the area information of this stub area includes an area number of two, an area offset of 200, an area size of 30, an area flag of one and an area span of one. The data of the hole area set on the optical disk 119-2 as the later part of the content area for the data of the content recorded on the optical disk 119-2 has been recorded on the same optical disk 119-2 as the data of the stub area immediately preceding this hole area. This hole area is the fourth area in the data of the content and the amount of the data of this hole area is 140 bytes. Thus, the area information of this hole area includes an area number of three, an area offset of 230, an area size of 140, an area flag of zero and an area span of zero.

The amount of the stub data of the stub area having the area number of two is the amount of content data readable out from the HDD 116 without exhausting the HDD 116 during a period in which the optical disk 119 mounted on the drive 118 is being replaced with another optical disk 119. The period in which the optical disk 119 mounted on the drive 118 is being replaced with another optical disk 119 is typically equal to the length of time it takes to dismount the optical disk 119-1 from the drive 118 after a process to read out data from the optical disk 119-1, convey the optical disk 119-1 to a disk slot 121, restore the optical disk 119-1 to the disk slot 121, convey the replacement optical disk 119-2 from another disk slot 121 to the drive 118, mount the optical disk 119-2 on the drive 118 and wait for the drive 118 to enter a state of being capable of reading out data from the optical disk 119-2.

In a word, the amount of data recorded in the vicinity of a boundary between the recording areas of optical disks 119 as stub data of a stub area is the amount of content data readable out from the HDD 116 without exhausting the HDD 116 during a period in which an operation to read out data from the optical disk 119-1 is being switched to an operation to read out data from the optical disk 119-2.

It is to be noted that the stub area can be placed as an area corresponding to content data in the vicinity of the head of the recording area of the optical disk 119-2 containing data to be read out after the operation to replace the optical disk 119-1 with the optical disk 119-2, or placed as an area corresponding to content data in the vicinity of the end of the recording area of the optical disk 119-1 containing data read out prior to the operation to replace the optical disk 119-1 with the optical disk 119-2.

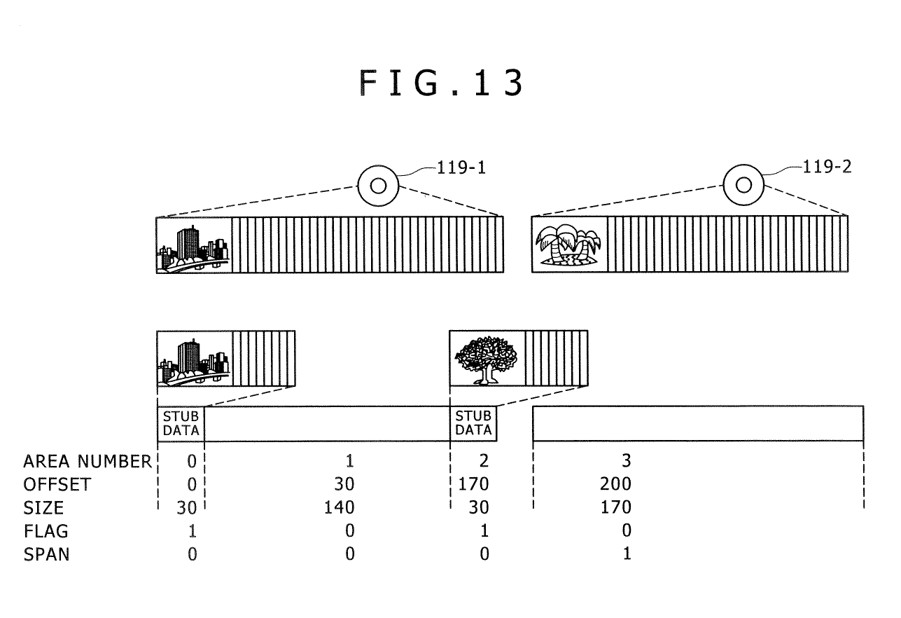

FIG. 13 is a diagram showing a configuration in which the stub area described above is placed as an area corresponding to content data in the vicinity of the end of the recording area of the optical disk 119-1 containing data read out prior to the operation to replace the optical disk 119-1 with the optical disk 119-2. The early part of the entire data of the content shown in FIG. 13 has been recorded on the optical disk 119-1. On the other hand, the content part following the early part recorded on the optical disk 119-1 as the early part of the entire data of the content has been recorded on the optical disk 119-2.

In the example shown in FIG. 13, a head portion included in a content area for the content data recorded on the optical disk 119-1 as a portion having a predetermined length is set as a stub area. In addition, the end of the remaining portion following the head portion in the content area for the content data recorded on the optical disk 119-1 is also set as a stub area. The end of the remaining portion has a predetermined length. An area between the head portion and the end of the remaining portion in the content area for the content data recorded on the optical disk 119-1 is set as a hole area. A content area for the content data recorded on the optical disk 119-2 is also set as a hole area.

The stub area at the head of the content data recorded on the optical disk 119-1 is the first area in the content and is used for storing data having an amount of 30 bytes. Thus, the area information of this stub area includes an area number of zero, an area offset of zero, an area size of 30, an area flag of one and an area span of zero. The data of the hole area of the content area for the content data recorded on the optical disk 119-1 has been recorded on the same optical disk 119-1 as the data of the stub data. This hole area is the second area in the content and the original data of the hole has an amount of 140 bytes. Thus, the area information of this hole area includes an area number of one, an area offset of 30, an area size of 140, an area flag of zero and an area span of zero.

The data of the stub area at the end of the content area for the content data recorded on the optical disk 119-1 has been recorded on the same optical disk 119-1 as the data of the stub data at the head of the content area. This hole area is the third area in the content and data stored in the hole area at the end of the content area has an amount of 30 bytes. Thus, the area information of this stub area includes an area number of two, an area offset of 170, an area size of 30, an area flag of one and an area span of zero.

The content area for the content data recorded on the optical disk 119-2 is a hole area. The data of this hole area has been recorded on the optical disk 119-2 while the data of the stub area having the area number of two has been recorded on the optical disk 119-1. This hole area is the fourth area in the content and the original data of the hole has an amount of 170 bytes. Thus, the area information of this stub area includes an area number of three, an area offset of 200, an area size of 170, an area flag of zero and an area span of one.

The amount of the data stored in the stub area having the area number of two is the amount of data readable out from the HDD 116 without exhausting the HDD 116 during a period in which an operation to read out data from the optical disk 119-1 is being switched to an operation to read out data from the optical disk 119-2 after an operation to read out content data of the hole area from the optical disk 119-1 is completed.

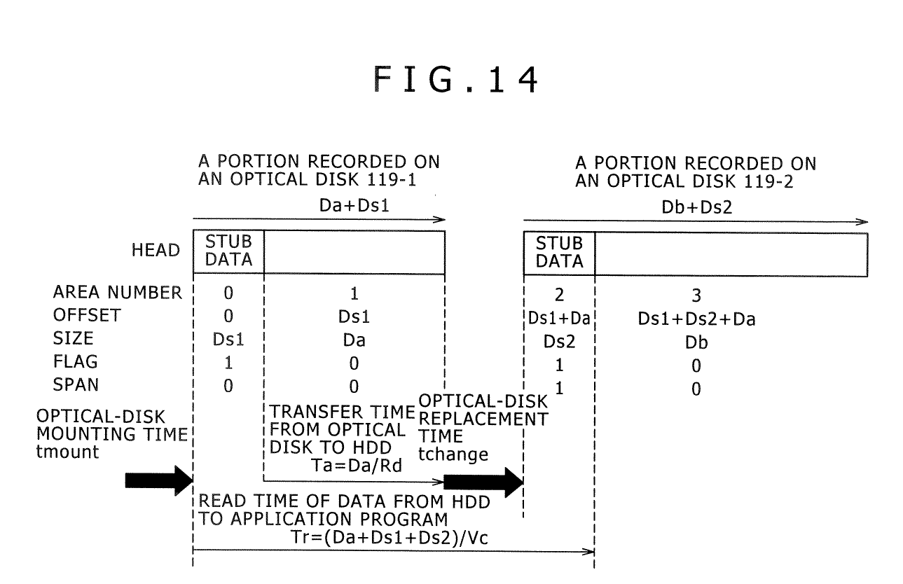

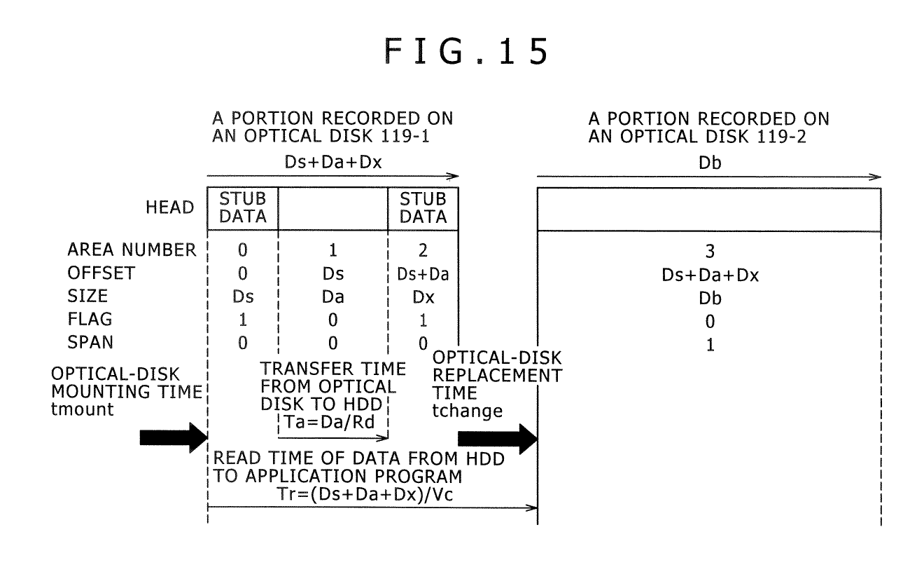

By referring to FIGS. 14 and 15, the following description explains the amount of data stored in a stub area corresponding to content data recorded in the vicinity of a boundary between the recording areas of optical disks 119.

In FIGS. 14 and 15, a data amount Ds also referred to as a stub data amount expressed in terms of MBs (megabytes) is the amount of data stored in a stub area placed at a position closest to a specific position in a content. The specific position in the content is a position corresponding to a time at which the optical disk 119-1 is replaced with the next optical disk 119-2.

For example, a data amount Ds1 shown in FIG. 14 is the amount of data stored at the head of the content area for the content data recorded on the optical disk 119-1. On the other hand, a data amount Ds2 is the amount of data stored at the head of the content area for the content data recorded on the optical disk 119-2.

A data amount Dx also expressed in terms of MBs is the amount of data stored in a stub area to be read out continuously without exhausting the HDD 116 while an optical disk 119 is being replaced with a next one as content data used to compensate a data reading operation for an interruption caused by the switching of the optical disk 119 to the next one. In a word, the data amount Dx is the amount of stub data used as a span. For example, as shown in FIG. 15, the data amount Dx is the amount of data stored in the stub area at the end of the content area for the content data recorded on the optical disk 119-1 to be read out continuously without exhausting the HDD 116 while the optical disk 119-1 is being replaced with the optical disk 119-2. As described above, the data amount Dx is thus the amount of stub data used as a span.

A read rate Vc is a normal read speed at which data of a content is read out by an application program 141. The read rate Vc is expressed in terms of MB/s (megabytes per second) units, which are each a constant average value. The read rate Vc can also be said as a speed at which data is read out by an application program 141. Expressed in terms of MB/s units, a reload rate Rd is a reloading speed at which data read out from an optical disk 119 is written into the HDD 116.

A time period tmount is the length of a period between the issuance of a command to mount an optical disk 119 onto the drive 118 and the establishment of a state in which the drive 118 is capable of reading out data from the optical disk 119 after the optical disk 119 has been mounted onto the drive 118. A time period tchange is the length of a period between the issuance of a command to replace an optical disk 119 mounted on the drive 118 with a replacement one and the establishment of a state in which the drive 118 is capable of reading out data from the replacement one after the optical disk 119 has been replaced with the replacement one.

Expressed in terms of MBs, a data amount Da is the amount of data of the last hole area in the area for the content recorded on an optical disk 119 to be read out prior to replacement of the optical disk 119 with another one.

A time period Ta is the length of time it takes to read out data recorded on an optical disk 119 containing data to be read out prior to replacement of the optical disk 119 and write the data read out from the optical disk 119 onto the HDD 116. In a word, the time period Ta is the length of time it takes to carry out a reloading process. The time period Ta is thus a ratio Da/Rd.

A time period Tr is the length of a period between the issuance of a command to start an operation to read out data of a content from an optical disk 119 to be replaced with a replacement disk and the establishment of a state in which the data of the content can be read out from the replacement disk. In other words, the time period Tr is the length of time it takes to continuously read out data from the HDD 116 and supply the data to the application program 141. In the configuration shown in FIG. 14, the time period Tr is found from an expression of (Da+Ds1+Ds2)/Vc and, in the configuration shown in FIG. 15, the time period Tr is found from an expression of (Da+Ds+Dx)/Vc.

As described above, in the configuration shown in FIG. 15, the data amount Dx is the amount of data stored in the stub area at the end of the content area for the content data recorded on the optical disk 119-1 to be read out continuously without exhausting the HDD 116 while the optical disk 119-1 is being replaced with the optical disk 119-2. The data amount Dx is large enough so that data being read out from the HDD 116 is not all read out to exhaust from the HDD 116 during a period in which the optical disk 119-1 is being replaced with the optical disk 119-2. Such a data amount Dx is found as follows.

In order to prevent a process to supply data from the HDD 116 to an application program 141 from being interrupted, Eq. (1) given below must be satisfied.
Tr>Ta+tmount+tchange (1)

Eq. (1) can be transformed into Eq. (2) described as follows:
(Da+Ds+Dx)/Vc>Da/Rd+(tmount+tchange) (2)

Let us assume that data is read out from an optical disk 119 at an average reload speed (or a reload rate Rd) which is k times the read rate Vc or Rd=k×Vc. In this case, Eq. (3) given below holds true:
Ds+Dx>(tmount+tchange)×Vc−Da(1−1/k) (3)

By substituting Ds into Eq. (3) for a product of (tmount×Vc), Eq. (4) given below can be obtained as an expression used for finding the data amount Dx.
Dx=tchange×Vc−Da(1−1/k) (4)

By the same token, the data amount Ds2 can be found from Eq. (5) given as follows:
Ds2=tchange×Vc−Da(1−1/k) (5)

By setting the amount of data stored in a stub area corresponding to content data recorded in the vicinity of a boundary between the recording areas of optical disks 119 at a proper value as described above, it is possible to prevent an operation to supply data from the HDD 116 to an application program 141 from being interrupted even if an optical disk 119 from which the data is being read out is replaced with another one.

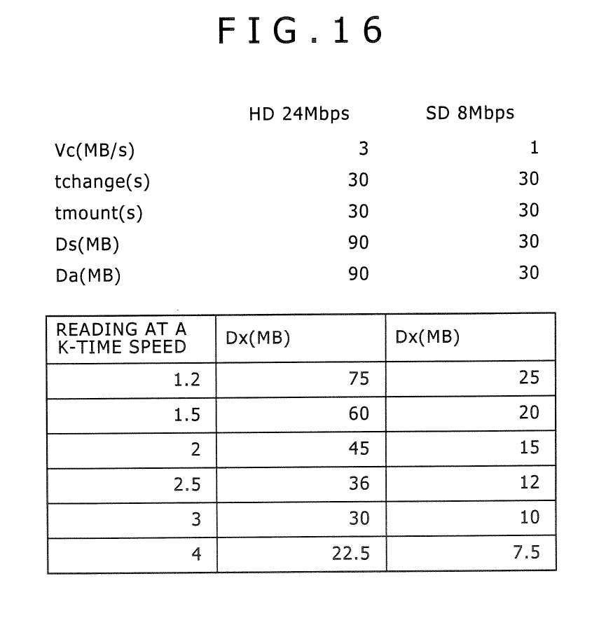

The following description gives typical values of the data amount Dx for a case in which 24 Mbps picture data used as HD picture data or 8 Mbps picture data used as SD picture data is recorded onto optical disks 119 to be read out later. The typical values are shown in FIG. 16.

In the following description, the time period tchange is 30 seconds and the time period tmount is also 30 seconds as shown in the figure.

In the case of the HD picture data, the read rate Vc is 3 MB/s, the data amount Ds is 90 MB and the data amount Da is also 90 MB.

In this case, if the multiplication coefficient k of the speed to read out data from an optical disk 119 is set at 1.2, the data amount Dx is found to be 75 MB. If the multiplication coefficient k of the speed to read out data from an optical disk 119 is set at 1.5, the data amount Dx is found to be 60 MB. If the multiplication coefficient k of the speed to read out data from an optical disk 119 is set at two, the data amount Dx is found to be 45 MB. If the multiplication coefficient k of the speed to read out data from an optical disk 119 is set at 2.5, the data amount Dx is found to be 36 MB. If the multiplication coefficient k of the speed to read out data from an optical disk 119 is set at three, the data amount Dx is found to be 30 MB. If the multiplication coefficient k of the speed to read out data from an optical disk 119 is set at four, the data amount Dx is found to be 22.5 MB.

In the case of the SD picture data, the read rate Vc is 1 MB/s, the data amount Ds is 30 MB and the data amount Da is also 30 MB.

In this case, if the multiplication coefficient k of the speed to read out data from an optical disk 119 is set at 1.2, the data amount Dx is found to be 25 MB. If the multiplication coefficient k of the speed to read out data from an optical disk 119 is set at 1.5, the data amount Dx is found to be 20 MB. If the multiplication coefficient k of the speed to read out data from an optical disk 119 is set at two, the data amount Dx is found to be 15 MB. If the multiplication coefficient k of the speed to read out data from an optical disk 119 is set at 2.5, the data amount Dx is found to be 12 MB. If the multiplication coefficient k of the speed to read out data from an optical disk 119 is set at three, the data amount Dx is found to be 10 MB. If the multiplication coefficient k of the speed to read out data from an optical disk 119 is set at four, the data amount Dx is found to be 7.5 MB.

It is obvious from the examples given above that the higher the speed at which data is read out from an optical disk 119, the smaller the value of the data amount Dx.

Typically, the migration file system 164 computes the data amount Dx as the required amount of stub data.

Assume for example that the recording/reproduction system 101 employs optical disks 119 of different types entailing different read speeds. In this case, for each of the optical disks 119, the required amount of stub data is computed by consideration of the speed at which data is read out from the optical disk 119. As a result, an HDD 116 having an excessively large storage capacity for recording stub data is no longer required.

By referring to a flowchart shown in FIG. 17, the following description explains processing carried out to write a content into an optical disk 119 when an application program 141 makes a request for the processing. At the first step S51 of the flowchart, the storage manager 114 supplies the data of a content to the HSM apparatus 113 and issues a command to the HSM apparatus 113, requesting the HSM apparatus 113 to write the data onto an optical disk 119. As requested, the HSM apparatus 113 receives the data of the content and writes the content data onto the HDD 116.

At a proper time, a shadowing process is carried out to record the content data written in the HDD 116 onto an optical disk 119 on the drive 118 too.

To put it in detail, the shadowing process is carried out as follows. At the next step S52, the HSM apparatus 113 identifies an optical disk 119 onto which the data of the content is to be recorded. For example, the storage server 165 reads out the volume ID of such an optical disk 119 having a free recording area from the store database 166 and the HSM apparatus 113 takes the optical disk 119 identified by the volume ID read out from the store database 166 as an optical disk 119 onto which the data of the content is to be recorded.

The storage server 165 issues a request to the media server 167 to identify a disk slot 121 accommodating the optical disk 119 identified by the volume ID. In accordance with the request, the media server 167 searches the volume database 168 used for storing volume IDs each used for identifying a disk slot 121 employed in the juke box 145 for a volume ID matching the volume ID included in the request made by the storage server 165. As a result of the search process carried out in accordance with the request, the volume database 168 outputs information on the disk slot 121 accommodating the optical disk 119 identified by the volume ID matching the volume ID included in the request made by the storage server 165. Then, the media server 167 supplies the information on the disk slot 121 to the storage server 165. In this way, the storage server 165 is capable of identifying the disk slot 121 accommodating the optical disk 119 identified by the volume ID as an optical disk 119 onto which the data of the content is to be recorded.

Then, at the next step S53, the HSM apparatus 113 drives the picker 122 to convey the optical disk 119 from the disk slot 121 to the drive 118 and mount the optical disk 119 onto the drive 118.

The operation carried out by the picker 122 is explained in detail as follows. The storage server 165 issues a command to the media server 167 to mount the optical disk 119 accommodated in the identified disk slot 121 onto the drive 118. In accordance with this command, the media server 167 requests the juke system 120 to mount the optical disk 119 accommodated in the identified disk slot 121 onto the drive 118. As requested by the media server 167, the juke system 120 executes control of driving the picker 122 employed in the juke box 145 to pick the optical disk 119 out off the identified disk slot 121, convey the optical disk 119 from the disk slot 121 to the drive 118 and mount the optical disk 119 onto the drive 118.

Then, at the next step S54, the HSM apparatus 113 starts an operation to write the content data already recorded in the HDD 116 onto an optical disk 119 mounted on the drive 118. In addition, at that time, the storage server 165 records information on the optical disk 119 into the store database 166. The information on the optical disk 119 includes the volume ID of the optical disk 119 and the start position of the data of the content in the optical disk 119.

Subsequently, at the next step S55, the HSM apparatus 113 produces a result of determination as to whether or not all the content of the data has been written onto an optical disk 119 mounted on the drive 118. If the determination result produced in the process carried out at the step S55 indicates that not all the content of the data has been written onto the optical disk 119, the flow of the processing procedure goes on to a step S56 at which the HSM apparatus 113 produces a result of determination as to whether or a free recording area is still left on the optical disk 119 mounted on the drive 118.

If the determination result produced in the process carried out at the step S56 indicates that a free recording area is still left on the optical disk 119 mounted on the drive 118, the flow of the processing procedure goes back to the step S55 to repeat the determination process of this step while continuing the operation to write the data of the content onto the optical disk 119 since a free recording area is still left on the optical disk 119.

If the determination result produced in the process carried out at the step S56 indicates that a free recording area is not left on the optical disk 119 mounted on the drive 118 anymore, on the other hand, the flow of the processing procedure goes on to a step S57 at which the HSM apparatus 113 identifies a next optical disk 119 onto which remaining data of the content is to be recorded in the same way as the process carried out at the step S52. This is because, since the remaining data of the content cannot be written onto the optical disk 119 currently mounted on the drive 118 anymore, the remaining data is written onto the next optical disk 119, which serves as a replacement disk of the optical disk 119 currently mounted on the drive 118. At that time, the storage server 165 records the size (or the amount) of the content data into the store database 166. The content data is the data already written on the optical disk 119 currently mounted on the drive 118 as an optical disk 119 exhausting its free recording area during the write data operation

Then, at the next step S58, the HSM apparatus 113 suspends the operation to write data of the content onto the optical disk 119 currently mounted on the drive 118 and requests the picker 122 to convey the optical disk 119 from the drive 118 to a disk slot 121 used for accommodating the optical disk 119 and restore the optical disk 119 into the disk slot 121.

To put it in detail, the storage server 165 issues a command to the media server 167 to put the optical disk 119 mounted on the drive 118 in the disk slot 121 identified in a process carried out at the step S52. Under control executed by the juke system 120 in accordance with the command, the picker 122 employed in the juke box 145 conveys the optical disk 119 ejected out off the drive 118 from the drive 118 to the identified disk slot 121 and restore the optical disk 119 in the disk slot 121.

Then, at the subsequent step S59, the HSM apparatus 113 drives the picker 122 to convey the next optical disk 119 from the disk slot 121 to the drive 118 and mount the optical disk 119 onto the drive 118 in the same way as the process carried out at the step S53. Subsequently, at the next step S60, the migration file system 164 employed in the HSM apparatus 113 computes the amount of necessary stub data. The stub data is data to be read out from the HDD 116 without exhausting the HDD 116 during a period in which an optical disk 119 mounted on the drive 118 is replaced with the next optical disk 119 so as to make an operation to read out the data of a content from optical disks 119 continuous. Typically, at the step S60, the migration file system 164 computes the amount of necessary stub data in accordance with Eq. (4) or (5).

Then, at the subsequent step S61, the migration file system 164 employed in the HSM apparatus 113 stores hint information in the extension attributes of the content. The hint information includes a hint size representing a quantity equal to or greater than the computed amount of necessary stub data. It is to be noted that, in this case, a hint priority also included in the hint information is set at a typical value of zero representing the highest priority. Details of the hint priority will be described later.

After the process of the step S61 is completed, the flow of the processing procedure goes back to the step S54 to resume the suspended processing to write the data of the content onto optical disks 119 and repeat the determination processes.

If the determination result produced in the process carried out at the step S55 indicates that all the data of the content has been written onto an optical disk 119 mounted on the drive 118, on the other hand, the flow of the processing procedure goes on to a step S62 at which processing to store the hint information is carried out. Details of the processing to store the hint information will be explained later.

Then, at the next step S63, the HSM apparatus 113 produces a result of determination as to whether or not execution of migration processing has been requested. If the result of determination indicates that execution of the migration processing has not been requested, the flow of the processing procedure goes back to the step S63 to repeat the determination process of this step. As a matter of fact, the determination process of the step S63 is carried out repeatedly till the result of determination indicates that execution of the migration processing is requested.

As the determination result produced in the process carried out at the step S63 indicates that execution of the migration processing has been requested, the flow of the processing procedure goes on to a step S64 at which processing to generate a cache file in a stub file state is carried out and, then, execution of the data write processing is ended. Details of the processing to generate a cache file in a stub file state will be described later.

As described above, if all the data of a content cannot be recorded onto one optical disk 119, the whole data of the content is recorded onto a plurality of optical disks 119 by spreading the data over the optical disks 119. If the data of a content is recorded onto a plurality of optical disks 119, the amount of necessary stub data is computed. As described above, the stub data is data to be read out from the HDD 116 without exhausting the HDD 116 during a period in which an optical disk 119 mounted on the drive 118 is replaced with the next optical disk 119 so as to make an operation to read out the data of the content from optical disks 119 continuous. The migration file system 164 stores the computed amount of stub data as the hint size included in the hint information.

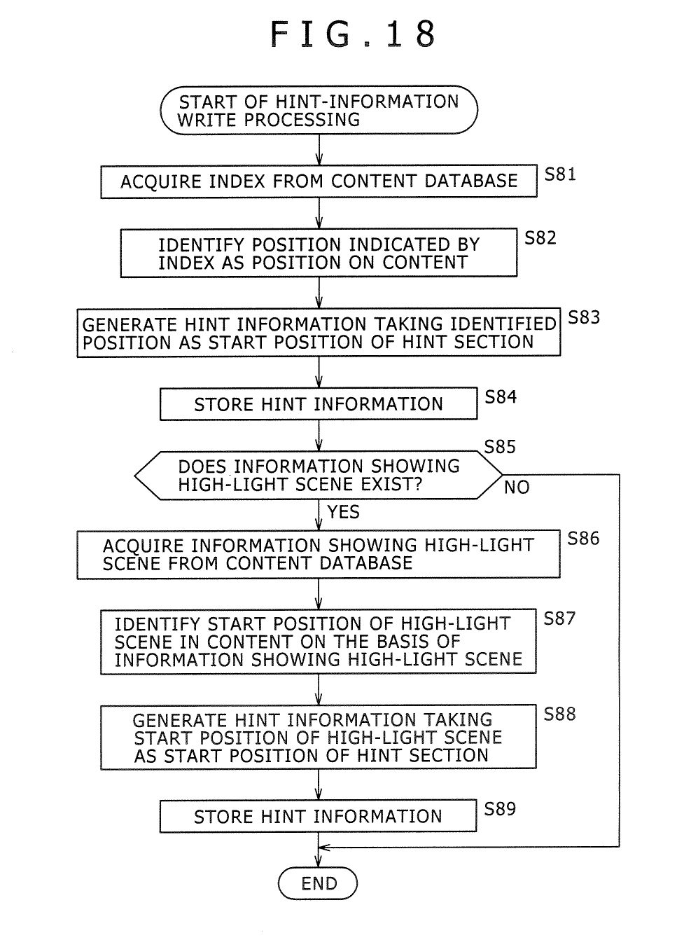

Next, the aforementioned processing to store the hint information is explained by referring to a flowchart shown in FIG. 18. At the first step S81 of the flowchart, an application program 141 acquires index information indicating an index position in a content from the content database 161 through the content manager 142. An index is information typically showing the beginning of a scene. Then, at the next step S82, the application program 141 identifies a position indicated by the index as a position in the content on the basis of the acquired index information.

Subsequently, at the next step S83, the application program 141 generates hint information taking the identified position as the start position of a hint section. A hint section is a portion (or a range) indicated by the hint information as a portion (or a range) of a content.

The hint information for a content is a hint as to which portion of the content is recorded in the HDD 116 as a cache file. By attaching hint information to a content (or the data of a content), any portion of the data of the content can be recorded in the cache area of the HDD 116 as stub data. That is to say, a portion indicated by the hint information as a part of the content can be stored in a cache file, which is then recorded in the HDD 116. In addition, a step-by-step migration process can be carried out by referring to the hint information.

The hint information includes a version number, a hint section length, a hint offset, a hint size, region flags, a hint priority and a timestamp. To put it in detail, a piece of hint information includes one version number and one section length. In addition, the piece of hint information also includes as many hint offsets, hint sizes, sets of region flags, region priorities and timestamps as hint sections. That is to say, a set of a hint offset, a hint size, a region flag, a region priority and a time stamp is information on one area.

A version number included in hint information shows the version of the hint information. The version number can be used for maintaining compatibility of the system and the software. The hint section length included in hint information is the total amount of data in all hint sections indicated by the hint information. Thus, if the amount of data in one hint section is a constant, a result of dividing the hint section length by the constant amount of data in one hint section is the number of hint sections.

Provided for each hint section, the hint offset is the distance between the start position of the hint section and the head of the data of the content. The hint offset is expressed in terms of data-amount units such as bytes. Also provided for each hint section, the hint size is the amount of data in the hint section. Typically, the hint size is also expressed in terms of bytes.

Region flags provided for each hint section include an attribute indicating whether or not the hint section is a section corresponding to an index, an attribute indicating whether or not the hint section is a section corresponding to a high-light scene and an attribute indicating whether or not the hint section is a section corresponding to a scene of importance. Software such as an operating system refers to the region flags in order to generate an event in accordance with an access.

A hint priority assigned to each hint section is a priority level at which the hint section migrates in case migration is required. The larger the value of a hint priority becomes, the easier the migration of the data of a portion corresponding to the hint section becomes. A hint priority set at zero indicates that the data of a portion corresponding to the hint section associated with the hint priority is kept in a cache file recorded in the HDD 116 serving as a primary storage device till the content including the portion is deleted from the recording/reproduction system 101. Hint priorities can be managed by, for example, assigning the hint priority of zero to partial data included in a content as a portion accessed frequently by an application program 141 or the operating system.

The timestamp of a hint section is a time/date at which the last access was made to the partial data included in a content as a portion corresponding to the hint section. An application program 141 or the operating system sets a timestamp.

Typically, an application program 141 sets a predetermined value in a version number.

For example, an application program 141 finds the amount of data between a specific position in a content and the head of the content. The specific position is a position identified in a process carried at the step S82 and represents a time in a process to reproduce the content. The application program 141 then uses the computed amount of data as a hint offset. Further, the application program 141 typically uses the predetermined value as a hint size. In addition, the application program 141 typically uses a predetermined value indicating that the hint section is a section corresponding to an index as a region flag.

On top of that, the application program 141 sets the hint priority at a value determined in advance. For example, the application program 141 sets the hint priority at zero for the initial index and at one for other indexes. The application program 141 sets the timestamp at a time/date of the last access.

In addition, the application program 141 multiplies the number of sections by the hint size in order to produce a product and uses the product as the hint section length

The application program 141 then creates hint information including a version number, a hint section length, a hint offset, a hint size, region flags, a hint priority and a timestamp, which are generated as described above, by arranging the version number, the hint section length, the hint offset, the hint size, the region flags, the hint priority and the timestamp in a predetermined order.

Then, at the next step S84, the application program 141 stores the hint information through the storage manager 114 in extension attributes recorded in the migration file system 164 of the HSM apparatus 113 as the attributes of the content.

Subsequently, at the next step S85, on the basis of the a response to an inquiry issued to the content manager 142, the application program 141 produces a result of determination as to whether or not the content database 161 includes information showing a high-light scene. If the determination result produced in the process carried out at the step S85 indicates that the content database 161 includes information showing a high-light scene, the flow of the processing procedure goes on to a step S86 at which the application program 141 inquires the information showing a high-light scene from the content database 161.

Then, at the next step S87, the application program 141 identifies the position of the beginning of the high-light scene in the content on the basis of the information showing the high-light scene. Typically, the application program 141 identifies the position of the beginning of the high-light scene in the content as a position determined by a time in the process to reproduce the content on the basis of the information showing the high-light scene.

Subsequently, at the next step S88, the application program 141 generates hint information taking the position of the beginning of the high-light scene as the start position of a hint section. Then, at the next step S89, the application program 141 stores the hint information through the storage manager 114 in extension attributes recorded in the migration file system 164 of the HSM apparatus 113 as the attributes of the content. Finally, the application program 141 ends the execution of this processing to write hint information.

If the determination result produced in the process carried out at the step S85 indicates that the content database 161 does not include information showing a high-light scene, on the other hand, the application program 141 ends the execution of this processing to write hint information by skipping the processes of the steps S86 to S89.

As described above, the amount of necessary stub data is added to hint information. The stub data is data to be read out from the HDD 116 without exhausting the HDD 116 during a period in which an optical disk 119 mounted on the drive 118 is replaced with the next optical disk 119 so as to make an operation to read out the data of a content from optical disks 119 continuous. In addition, the hint information is generated on the basis of index information or information showing a high-light scene, and then stored in extension attributes. By attaching hint information to a content (or the data of a content), any portion of the data of the content can be recorded in the cache area of the HDD 116 as stub data. Thus, the data of the content can be read out at a higher speed. Examples of the portion of the data of the content are the data at a position indicated by the index and the data of a high-light scene.

It is to be noted that the basis used for generation of the hint information is not limited to the index information and the information showing a scene. For example, the hint information can also be generated on the basis of other information desired by the user. Examples of the other information desired by the user are information showing a scene of importance and play-list information.

By referring to the hint information recorded as described above, a step-by-step migration process can be carried out.

It is to be noted that the hint information may include values entered directly by the user by carrying out operations. In addition, the hint information can also be generated by a program other than the application program 141. An example of the other program is the operating system.

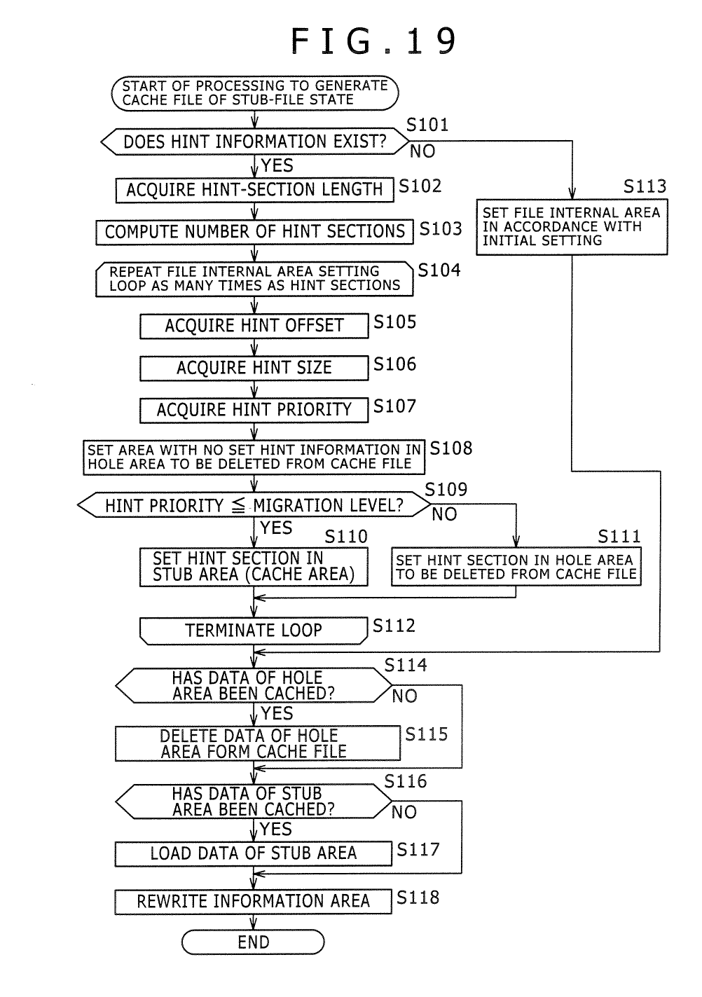

FIG. 19 shows a flowchart to be referred to in explanation of processing to generate a cache file in a stub file state. At the first step S101 of the flowchart, the storage manager 114 reads out extension attributes of a content from the migration file system 164 employed in the HSM apparatus 113, and produces a result of determination as to whether or not the extension attributes include hint information. If the determination result produced in the process carried out at the step S101 indicates that the extension attributes include hint information, the flow of the processing procedure goes on to a step S102 at which the storage manager 114 extracts the hint information from the extension attributes read out from the migration file system 164 employed in the HSM apparatus 113 as the extension attributes of the content. Then, the storage manager 114 acquires a hint section length showing the total amount of data in all hint sections from the hint information.

Subsequently, at the next step S103, the storage manager 114 divides the hint section length by the amount of data in one hint section in order to find the number of hint sections.

It is to be noted that the storage manager 114 may also read out pieces of hint information from the extension attributes and find the number of hint sections by counting the number of pieces of hint information.

Then, for each of the hint sections, the storage manager 114 executes a loop of steps S104 to S112. That is to say, the storage manager 114 executes a loop control process to implement the loop of the steps S104 to S112 as many times as the hint sections. To be more specific, the storage manager 114 carries out processes of steps S105 to S111 for each of the hint sections.

At the step S105, the storage manager 114 acquires a hint offset showing the start position of a predetermined hint section from the hint information. Then, at the next step S106, the storage manager 114 acquires a hint size showing the amount of data in the hint section from the hint information. Subsequently, at the next step S107, the storage manager 114 acquires a hint priority showing a priority level assigned to the hint section from the hint information.

Then, at the next step S108, the storage manager 114 sets an area with no hint information in a hole area to be deleted from a cache file recorded in the HDD 116.

Subsequently, at the next step S109, the storage manager 114 produces a result of determination as to whether or not the hint priority is equal to or lower than a migration level set in advance. If the determination result produced in the process carried out at the step S109 indicates that the hint priority is equal to or lower than the migration level, the flow of the processing procedure goes on to a step S110 at which the storage manager 114 sets the hint section having the hint priority in a stub area. The stub area is a cache area.

The migration level is a criterion as to whether a hint section is to be cached. Typically, the storage manager 114 stores the migration level determined in advance or determines a migration level on the basis of a date/time at which the last access was made to the content associated with the file attributes. In addition, the storage manager 114 may carry out a determination process based on a migration level supplied by the application program 141 in accordance with an operation carried out by the user.

If the determination result produced in the process carried out at the step S109 indicates that the hint priority is higher than the migration level, on the other hand, the flow of the processing procedure goes on to a step S111 at which the storage manager 114 sets the hint section having the hint priority in a hole area to be deleted from the cache file.

The processes of the steps S105 to S110 or S105 to Sill are carried out for every hint section in order to set an area covering the hint section in a stub area or a hole area. It is to be noted that an area with no hint info is set in a hole area.

After the storage manager 114 executes the loop of the steps S104 to S112 as many times as the hint sections, the flow of the processing procedure goes on to a step S114.

If the determination result produced in the process carried out at the step S101 indicates that the extension attributes do not include hint information, on the other hand, the flow of the processing procedure goes on to a step S113 at which the storage manager 114 sets a file internal area in accordance with initial setting. That is to say, at the step S113, the storage manager 114 sets the area of the content in a stub or hole area in accordance with initial setting. Then, the flow of the processing procedure goes on to the step S114.

At the step S114, the storage manager 114 produces a result of determination as to whether or not the data of a hole area has been cached. If the result of the determination indicates that the data of a hole area has been cached, the flow of the processing procedure goes on to a step S115 at which the HSM apparatus 113 is requested to delete (or erase) the data of the hole area from the cache file. As requested, the HSM apparatus 113 deletes the data of the hole area from the cache file in accordance with control executed by the storage manager 114. Then, the flow of the processing procedure goes on to a step S116.

If the determination result produced in the process carried out at the step S114 indicates that the data of a hole area has not been cached, on the other hand, the flow of the processing procedure goes on to a step S116 directly by skipping the step S115. This is because it is not necessary to carry out the process to delete the data of the hole area from the cache file.

At the step S116, the storage manager 114 produces a result of determination as to whether or not the data of a stub area has been recorded in a cache file, that is, whether or not the data of a stub area has been cached. If the result of the determination indicates that the data of a stub area has not been cached, the flow of the processing procedure goes on to a step S117 at which the HSM apparatus 113 is requested to reload the data of the stub area into the cache file. As requested, the HSM apparatus 113 mounts an optical disk 119 used for recording the entire data of the content onto the drive 118 in accordance with control executed by the storage manager 114. Then, the HSM apparatus 113 drives the drive 118 to read out data of the content from the optical disk 119 and stores the data into a cache file recorded in the HDD 116. In this way, the data of the stub area is reloaded into the cache file. Then, the flow of the processing procedure goes on to a step S118.

If the determination result produced in the process carried out at the step S116 indicates that the data of a stub area has been cached, on the other hand, the flow of the processing procedure goes on to the step S118 directly by skipping the step S117. This is because it is not necessary to carry out the process to reload the data of the stub area into the cache file.

At the step S118, the storage manager 114 requests the migration file system 164 employed in the HSM apparatus 113 to update the area information included in the extension attributes of the content to reflect the result of the process to delete data from the cache file or the process to reload data from the optical disk 119 into the cache file.

A cache file in a stub file state is generated by carrying out the processing described above.

If the processing to generate a cache file in a stub file state on the basis of a migration level having an arbitrary value i is applied to such a cache file in stub file state, a cache file placed in a stub file state as a cache file including hint sections each having a hint priority not exceeding the migration level i is resulted in.

As described above, a step-by-step migration process can be carried out on the basis of hint priorities.

It is to be noted that, if the hint priority of the hint information provided for a stub area used for recording stub data is set at zero, for example, the stub data is kept in a cache file recorded in the HDD 116 till the content including the stub data is deleted from the recording/reproduction system 101. As described earlier, the stub data is data to be read out from the HDD 116 without exhausting the HDD 116 during a period in which an optical disk 119 mounted on the drive 118 is replaced with the next optical disk 119 so as to make an operation to read out the data of a content from optical disks 119 continuous.

The following description explains processing to read out data of a content by using a cache file generated as described above as a cache file in a stub file state.

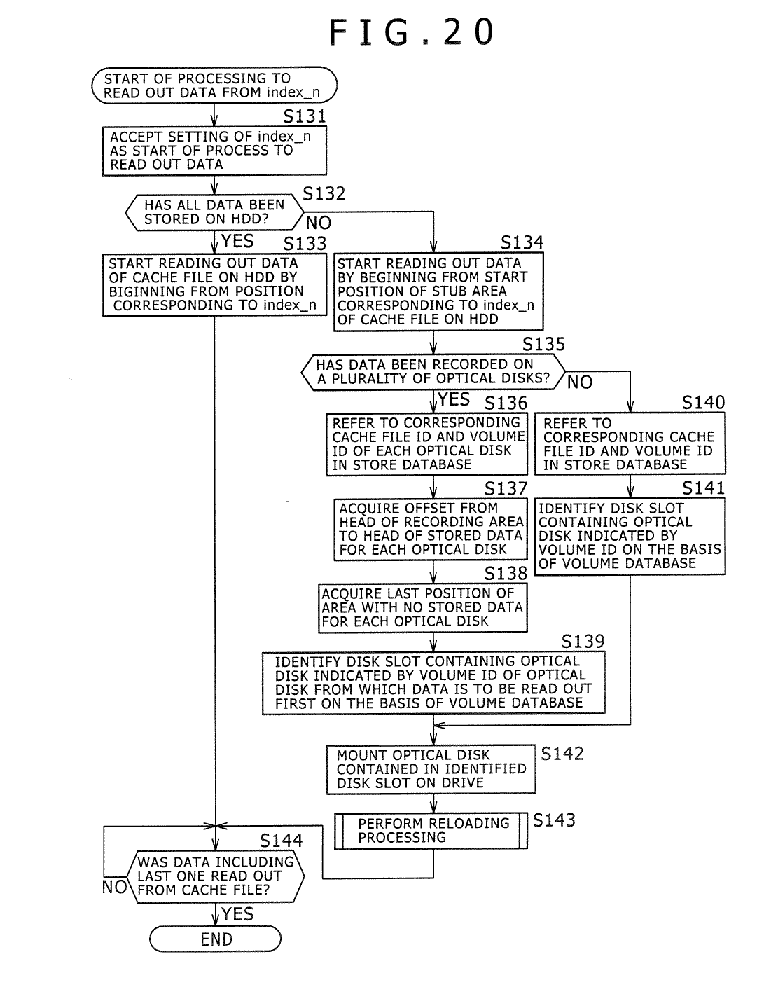

FIG. 20 shows a flowchart to be referred to in explanation of processing to read out data of a content from index_n. At the first step S131 of the flowchart, the file I/O manager 163 employed in the storage manager 114 receives specified index_n serving as the start of an operation to read out data of a content. To put it in more detail, the application program 141 receives an index selected by the user by carrying out an operation as the start of a reproduction process. The application program 141 supplies data representing the index selected by the user as the start of a reproduction process to the file I/O manager 163. That is to say, the file I/O manager 163 receives the data from the application program 141 as index_n specified by the user and used as the start of an operation to read out data of a content. The storage manager 114 then issues a command to the HSM apparatus 113 to carry out a reproduction process starting at index_n.

Then, at the next step S132, the storage manager 114 produces a result of determination as to whether or not all the data of the content to be reproduced has been recorded in the HDD 116 as a cache file, that is, whether or not all the data of the content to be read out has been stored in the HDD 116. If the determination result produced in a process carried out at the step S132 indicates that all the data of the content to be read out has been stored in the HDD 116, the flow of the processing procedure goes on to a step S133 at which the storage manager 114 issues a command to the HSM apparatus 113 to start a process of reading out data of the content from a position corresponding to index_n. In accordance with the command, the HSM apparatus 113 drives the HDD 116 to carry out a process of reading out data of the content from the cache file, starting with data at a position corresponding to index_n. After the process of the step S133 is completed, the flow of the processing procedure goes on to a step S144.

If the determination result produced in a process carried out at the step S132 indicates that not all the data of the content to be read out has been stored in the HDD 116, on the other hand, the flow of the processing procedure goes on to a step S134 at which the storage manager 114 issues a command to the HSM apparatus 113 to start a process of reading out data of the content from a position corresponding to index_n. In accordance with the command, the HSM apparatus 113 drives the HDD 116 to carry out a process of reading out data of the content from the cache file recorded in the HDD 116, starting with data at a position corresponding to index_n.

As a result, the content is reproduced immediately.

The command issued by the storage manager 114 to the HSM apparatus 113 as a request for an operation to transfer data of a content from an optical disk 119 to the HDD 116 is referred to as a reloading command.

Then, at the next step S135, on the basis of information stored in the store database 166 as information indicating whether or not the entire data of the content has been recorded (or preserved) on a plurality of optical disks 119, the HSM apparatus 113 produces a result of determination as to whether or not the data of the content has been recorded on a plurality of optical disks 119. If the determination result produced in the process carried out at the step S135 indicates that the entire data of the content has been recorded on a plurality of optical disks 119, the flow of the processing procedure goes on to a step S136 at which the HSM apparatus 113 refers to the store database 166 for the cache file ID of each cache file and the volume ID of each of the optical disks 119.

Then, at the next step S137, for each of the optical disks 119, the HSM apparatus 113 acquires an offset from the store database 166 as a distance between the beginning of the recording area of the optical disk 119 and the beginning of content data recorded on the optical disk 119 as the data to be read out. Subsequently, at the next step S138, for each of the optical disks 119, the HSM apparatus 113 acquires the last position of a hole area having no data stored therein from the store database 166. To put it concretely, at the step S138, for each of the optical disks 119, the HSM apparatus 113 acquires an address in the optical disk 119. The address is an address showing the rearmost position of data recorded optical disk 119 as the data to be read out but not recorded yet in the HDD 116.

Then, at the next step S139, on the basis of the volume database 168, the storage server 165 identifies a disk slot 121 used for accommodating an optical disk 119 identified by a volume ID assigned to an optical disk 119 from which data is to be read out initially. After the process of the step S139 is completed, the flow of the processing procedure goes on to a step S142.

If the determination result produced in the process carried out at the step S135 indicates that the entire data of the content has been recorded not on a plurality of optical disks 119, that is, the entire data of the content has been recorded on an optical disk 119 only, on the other hand, the flow of the processing procedure goes on to a step S140 at which the HSM apparatus 113 refers to the store database 166 for the cache file ID of the cache file and the volume ID of the optical disk 119.

Then, at the next step S141, on the basis of the volume database 168, the storage server 165 identifies a disk slot 121 used for accommodating the optical disk 119 identified by the volume ID. After the process of the step S141 is completed, the flow of the processing procedure goes on to the step S142.

At the step S142, the storage server 165 gives a command to the media server 167 to mount the optical disk 119 accommodated in the identified disk slot 121 on the drive 118. In accordance with this command, the media server 167 requests the juke system 120 through the changer driver 143 to mount the optical disk 119 accommodated in the identified disk slot 121 on the drive 118. That is to say, under control executed by the juke system 120, the picker 122 employed in the juke box 145 brings out the optical disk 119 from the identified disk slot 121, conveys the optical disk 119 from the disk slot 121 to the drive 118 and places (or mounts) the optical disk 119 on the drive 118.

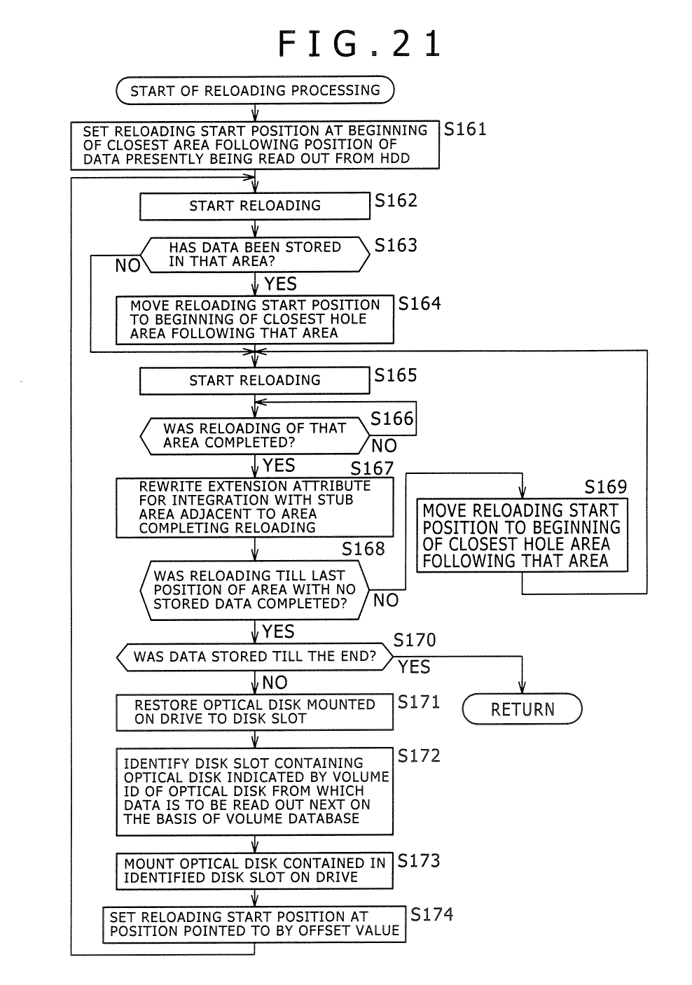

Then, at the next step S143, reloading processing is carried out. Details of the reloading processing will be described later by referring a flowchart shown in FIG. 21.

After the process of the step S143 is completed, the flow of the processing procedure goes on to a step S144.

At the step S144, the storage manager 114 produces a result of determination as to whether or not the data has been read out to the end of the cache file. If the result of determination indicates that the data has not been read out to the end of the cache file, the flow of the processing procedure goes back to the step S144 at which the determination process of this step is repeated. As a matter of fact, the determination process is carried out repeatedly till the result of determination indicates that the data has been read out to the end of the cache file.

As the determination result produced in the process carried out at the step S144 indicates that the data has been read out to the end of the cache file, the execution of the processing to read out data from index_n is ended.

Next, by referring a flowchart shown in FIG. 21, the following description explains details of the reloading processing carried out in the process of the step S143 of the flowchart shown in FIG. 20. At the first step S161 of the flowchart shown in FIG. 21, the storage manager 114 gives a command to the HSM apparatus 113 to start a reloading process at a predetermined position specified in the command. In accordance with the command, the migration file system 164 employed in the HSM apparatus 113 sets the start position of the reloading process at the beginning of an area existing at a location following the location of data being read out presently from the HDD 116 as an area closest to the data.

Then, at the next step S162, the storage server 165 employed in the HSM apparatus 113 starts the reloading process. That is to say, the storage server 165 requests the drive 118 to read out data at the start position of the reloading process from the optical disk 119 mounted on the drive 118 and store the data read out from the optical disk 119 in a predetermined area of the cache file recorded in the HDD 116.

Subsequently, at the next step S163, the migration file system 164 produces a result of determination as to whether or not the area is an area with stored data. If the result of the determination indicates that the area is an area with stored data, the flow of the processing procedure goes on to a step S164 at which the start position of the reloading process is shifted to the beginning of a hole area placed behind the area as a hole area closest to the area. If the determination result produced in the process carried out at the step S163 indicates that the area is not an area with stored data, on the other hand, the process of the step S164 is skipped.

Then, at the next step S165, the storage server 165 employed in the HSM apparatus 113 starts the reloading process.

Subsequently, at the next step S166, the migration file system 164 produces a result of determination as to whether or not the reloading process of the area has been completed. If the result of the determination indicates that the reloading process of the area has not been completed yet, the flow of the processing procedure goes back to the step S166 to repeat the determination process of this step. As a matter of fact, the determination process is carried out repeatedly till the result of the determination indicates that the reloading process of the area has been completed.

As the determination result produced in the process carried out at the step S166 indicates that the reloading process of the area has been completed, the flow of the processing procedure goes on to a step S167 at which the migration file system 164 updates the extension attributes to reflect the fact that the area completing the reloading process has been joined to a stub area adjacent to the area.

Then, at the next step S168, on the basis of the span included in the area information, the migration file system 164 produces a result of determination as to whether or not the reloading process has been completed to the last position of the area with no stored data for the optical disk 119 mounted on the drive 118.

To put it in detail, let us assume for example that a stub area used for storing content data with a sufficient amount not causing an operation to read out content data from the HDD 116 to exhaust the HDD 116 during a period in which an optical disk 119 mounted presently on the drive 118 is replaced with the next one is placed at a location corresponding to content data stored in the vicinity of the head of the recording area of the next optical disk 119 containing data to be read out after the replacement of the optical disk 119 mounted presently on the drive 118 with the next optical disk 119. In this case, the migration file system 164 produces a result of determination as to whether or not the reloading process of data being read out has been completed to the last position of the hole area of the data being read out and, on the basis of the span of the area information of the next stub area, the migration file system 164 produces a result of determination as to whether or not the data stored in the next stub area has been recorded on an optical disk 119 different from the optical disk 119 mounted presently on the drive 118. By carrying out these two predetermined processes, the migration file system 164 produces a result of determination as to whether or not the reloading process has been completed to the last position of the area with no stored data for the optical disk 119 mounted on the drive 118.

As another example, let us assume that a stub area used for storing content data with a sufficient amount not causing an operation to read out content data from the HDD 116 to exhaust the HDD 116 during a period in which an optical disk 119 mounted presently on the drive 118 is replaced with the next one is placed at a location corresponding to content data stored in the vicinity of the tail of the recording area of the optical disk 119 containing data to be read out prior to the replacement of the optical disk 119 mounted presently on the drive 118 with the next optical disk 119. In this case, the migration file system 164 produces a result of determination as to whether or not the reloading process of data being read out has been completed to the last position of the area used for storing the data being read out and, on the basis of the span of the area information of the next hole area, the migration file system 164 produces a result of determination as to whether or not the data to be reloaded next has been recorded on an optical disk 119 different from the optical disk 119 mounted presently on the drive 118. By carrying out these two predetermined processes, the migration file system 164 produces a result of determination as to whether or not the reloading process has been completed to the last position of the area with no stored data for the optical disk 119 mounted on the drive 118.

It is to be noted that, as an alternative, at the step S168, on the basis of the position acquired in the process carried out at the step S138, the migration file system 164 may also produce a result of determination as to whether or not the reloading process has been completed to the last position of the area with no stored data for the optical disk 119 mounted on the drive 118.

If the determination result produced in the process carried out at the step S168 indicates that the reloading process has not been completed to the last position of the area with no stored data for the optical disk 119 mounted on the drive 118, the flow of the processing procedure goes on to a step S169 at which the migration file system 164 shifts the start position of the reloading process to the beginning of a hole area placed behind the area as a hole area closest to the area. This is because not all the data of the content recorded on the optical disk 119 mounted on the drive 118 has been reloaded. Then, the flow of the processing procedure goes back to the step S165.

If the determination result produced in the process carried out at the step S168 indicates that the reloading process has been completed to the last position of the area with no stored data for the optical disk 119 mounted on the drive 118, on the other hand, the flow of the processing procedure goes on to a step S170 at which the migration file system 164 produces a result of determination as to whether or not the data of the content has been stored to the end, that is, whether or not the reloading process has been completed to the end of the cache file.

If the determination result produced in the process carried out at the step S170 indicates that the data of the content has not been stored to the end, that is, if the determination result indicates that the reloading process has not been completed to the end of the cache file, the flow of the processing procedure goes on to a step S171 at which the migration file system 164 drives the picker 122 to convey the optical disk 119 ejected out from the drive 118 to a disk slot 121 used for accommodating the optical disk 119 and restore the optical disk 119 into the disk slot 121.

Then, at the next step S172, on the basis of the volume database 168, the migration file system 164 identifies a disk slot 121 used for accommodating an optical disk 119 identified by a volume ID assigned to an optical disk 119 from which data is to be read out next. Subsequently, at the next step S173, the migration file system 164 drives the picker 122 to bring out an optical disk 119 from the identified disk slot 121, convey the optical disk 119 from the disk slot 121 to the drive 118 and mount the optical disk 119 onto the drive 118.

Then, at the next step S174, the migration file system 164 sets the reloading start position at a position pointed to by an offset value for the optical disk 119 mounted on the drive 118. Subsequently, the flow of the processing procedure goes back to the step S162 to repeat the processes described so far.

If the determination result produced in the process carried out at the step S170 indicates that the data of the content has been stored to the end, that is, if the determination result indicates that the reloading process has been completed to the end of the cache file, on the other hand, the execution of the reloading processing is ended.

As described above, prior to an operation to read out data not stored in a cache file in the HDD 116 in advance during a period in which content data is being read out from the cache file, data of a hole area is read out from an optical disk 119 mounted on the drive 118 and stored in the cache file. Since the drive 118 reads out data, which is required in a process to reproduction a content, from the optical disk 119 at a high reloading speed in comparison with a reading speed at which data is read out by the application program 141 from the HDD 116, data not stored in a cache file in the HDD 116 prior to the start of a process to reproduce a content is stored into the cache file in the HDD 116 before the process to reproduce a content is started. Thus, data required in a process to reproduction a content can always be read out from the HDD 116.

Since content data stored in the HDD 116 has a sufficient amount allowing an operation of reading out content data from the HDD 116 to be carried out continuously without exhausting the HDD 116 during a period in which an optical disk 119 mounted presently on the drive 118 is replaced with the next one, in the processes of the steps S171 to S173, content data can be read out from the HDD 116 without an interruption even during the period to replace an optical disk 119 mounted presently on the drive 118 with the next one.

As a result, when an operation to read out the data of a content is requested, the content of the data can be read out from the HDD 116 at a high speed almost without a wait time and without a suspension. That is to say, in the case of a sound or picture content, the sound or picture of the content can be reproduced without a sound or picture interruption caused by a suspension of the process to reproduce the sound or the picture.

In addition, since content data is read out from an optical disk 119 on the drive 118 in advance and recorded in the HDD 116, the drive 118 can be released early in comparison with an operation to reproduce directly data read out from the optical disk 119. That is to say, the performance of the drive 118 can be fully displayed and the drive 118 can be utilized with a high degree of efficiency. The performance of the drive 118 includes the high speed at which data is read out from an optical disk 119 mounted on the drive 118.

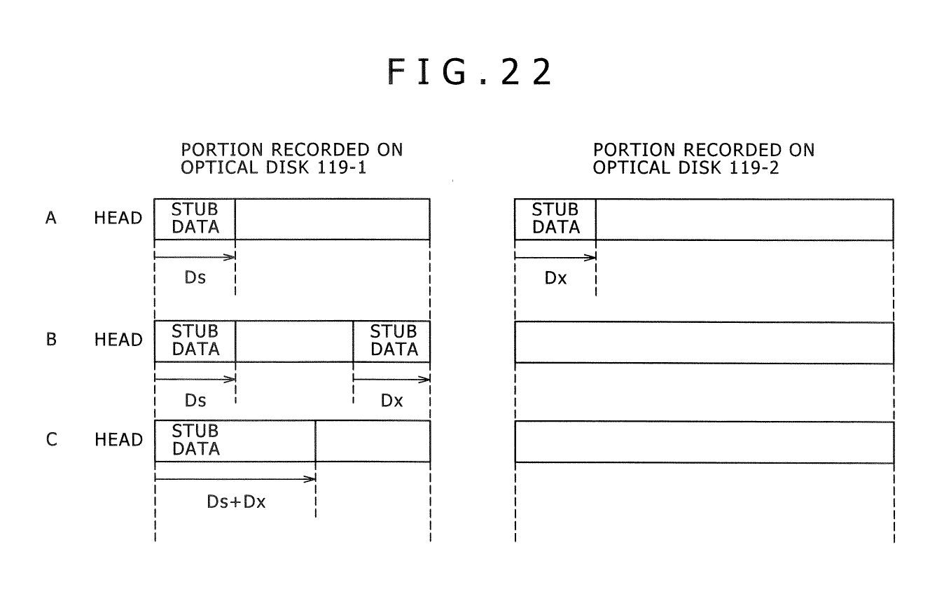

It is to be noted that, as described earlier by referring to FIGS. 12 and 13, a stub area used for storing data with a sufficient amount allowing an operation of reading out content data from the HDD 116 to be carried out continuously without exhausting the HDD 116 during a period in which an optical disk 119 mounted presently on the drive 118 is replaced with the next one can be placed at a location corresponding to content data stored in the vicinity of the head of the recording area of the next optical disk 119 containing data to be read out after the replacement of the optical disk 119 mounted presently on the drive 118 with the next optical disk 119, or placed at a location corresponding to content data stored in the vicinity of the tail of the recording area of the optical disk 119 containing data to be read out prior to the replacement of the optical disk 119 mounted presently on the drive 118 with the next optical disk 119 as shown in FIG. 22.

In addition, if data read out by the drive 118 from an optical disk 119 mounted on the drive 118 is once recorded onto the HDD 116 to be read out by an application program 141, a stub area used for storing data with a sufficient amount allowing an operation of reading out content data from the HDD 116 to be carried out continuously without exhausting the HDD 116 during a period in which the optical disk 119 mounted presently on the drive 118 is replaced with the next one can be placed at a location immediately following the first stub area corresponding to content data recorded on the optical disk 119 including data to be read out prior to the replacement of the optical disk 119 mounted presently on the drive 118 with the next optical disk 119, or placed at a location immediately following the last stub area corresponding to content data recorded on the optical disk 119 including data to be read out prior to the replacement of the optical disk 119 mounted presently on the drive 118 with the next optical disk 119. In this case, the amount of the stub data is equal to the size of the two combined areas. For example, the amount of the stub data is equal to (the data amount Ds+the data amount Dx).

It is to be noted that, as will be described later in detail, if content data not recorded in a cache file is read out from an optical disk 119 mounted on the drive 118 in an operation to reproduce a content directly from the data read out from the optical disk 119, a stub area used for storing data with a sufficient amount allowing an operation of reading out content data from the HDD 116 to be carried out continuously without exhausting the HDD 116 during a period in which the optical disk 119 mounted presently on the drive 118 is replaced with the next one can be placed at a location corresponding to content data stored in the vicinity of the head of the recording area of the next optical disk 119 containing data to be read out after the replacement of the optical disk 119 mounted presently on the drive 118 with the next optical disk 119, or placed at a location corresponding to content data stored in the vicinity of the tail of the recording area of the optical disk 119 containing data to be read out prior to the replacement of the optical disk 119 mounted presently on the drive 118 with the next optical disk 119 as shown in FIG. 22.

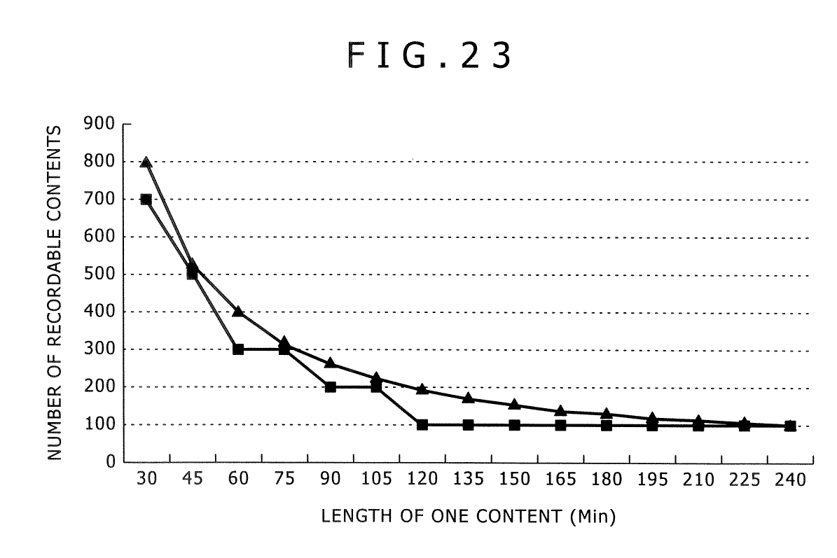

Let us assume that 100 optical disks used for recording data of contents in a no-span mode or a span mode each have a storage capacity of 43 GB. In the no-span mode, the entire data of one content cannot be recorded on more than one optical disk. In the span mode, on the other hand, the entire data of one content can be stored in a plurality of optical disks by being spread over the optical disks. FIG. 23 is a diagram showing a curve representing a relation between the number of recordable contents and the length of each content for the no-span mode and a curve representing a relation between the number of recordable contents and the length of each content for the span mode.

The data shown in the figure has been obtained for a content bit rate of 24 Mbps. In addition, in the case of the no-span mode, a margin of 512 KB has been provided for every content.

The data shown in FIG. 23 represents the number of recordable contents for each of content reproduction durations in the range 30 minutes to 240 minutes. In FIG. 23, each triangle represents data for the span mode while each rectangle represents data for the no-span mode.

For a content reproduction duration of 30 minutes, the number of contents recordable in the span mode is about 800 and the number of contents recordable in the no-span mode is about 700. For a content reproduction duration of 60 minutes, the number of contents recordable in the span mode is about 400 and the number of contents recordable in the no-span mode is about 300. For a content reproduction duration of 120 minutes, the number of contents recordable in the span mode is about 200 and the number of contents recordable in the no-span mode is about 100.

For a content reproduction duration in the range 120 minutes to 240 minutes, the number of contents recordable in the no-span mode is a constant of about 100. For a content reproduction duration in the range 120 minutes to 240 minutes, the number of contents recordable in the span mode decreases from about 200 to about 100 as the content reproduction duration increases from 120 minutes to 240 minutes.

It is obvious from the figure that, for the same content reproduction duration, the number of contents recordable in the span mode is greater than the number of contents recordable in the non-span mode.

In addition, it is possible to provide a configuration in which content data not recorded in a cache file is read out from an optical disk 119 mounted on the drive 118 in an operation to reproduce a content directly from the data read out from the optical disk 119.

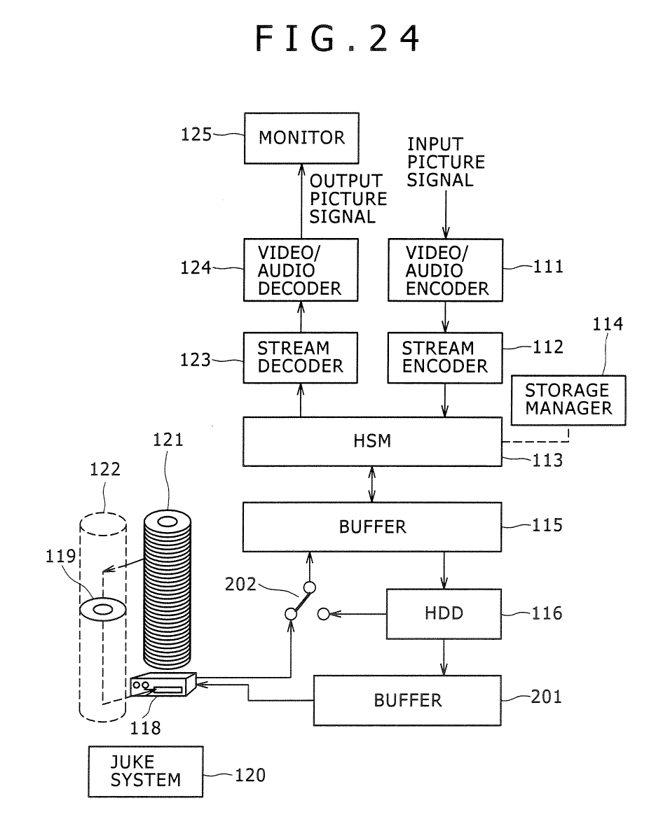

FIG. 24 is a block diagram showing another configuration of the recording/reproduction system 101 according to the embodiment of the present invention. The recording/reproduction system 101 shown in FIG. 24 includes a video/audio encoder 111, a stream encoder 112, an HSM apparatus 113, a storage manager 114, a buffer 115, an HDD (Hard Disk Drive) 116, a drive 118, an optical disk 119, a juke system 120, disk slots 121, a picker 122, a stream decoder 123 and a video/audio decoder 124, which are identical with their respective counterparts employed in the configuration of the recording/reproduction system 101 shown in FIG. 4. However, the configuration shown in FIG. 24 is different from the configuration shown in FIG. 24 in that the configuration shown in FIG. 24 does not include the buffer 117 but includes a buffer 201 and a selector 202 instead.

Description of the components common to the configuration shown in FIG. 4 is not repeated.

The HDD 116 supplies a data stream recorded therein to the buffer 201 or the selector 202.

The buffer 201 is a semiconductor memory or the recording area of a portion of the HDD 116. The buffer 201 is a memory used for temporarily storing a data stream received from the HDD 116. The buffer 201 supplies a data stream stored therein to the drive 118.

The selector 202 is a component for selecting output data from the drive 118 or output data from the HDD 116 in accordance with control executed by the HSM apparatus 113 and outputting the selected data to the buffer 115. The buffer 115 is a memory for receiving data selected by the selector 202 and storing the data. The data selected by the selector 202 is the output data from the drive 118 or the output data from the HDD 116.

It is to be noted that the selector 202 can be implemented as hardware or processing software executed to carry out a function equivalent to the selector 202.

As an alternative, the selector 202 may select output data from the drive 118 or output data from the HDD 116 in accordance with control executed by the storage manager 114.

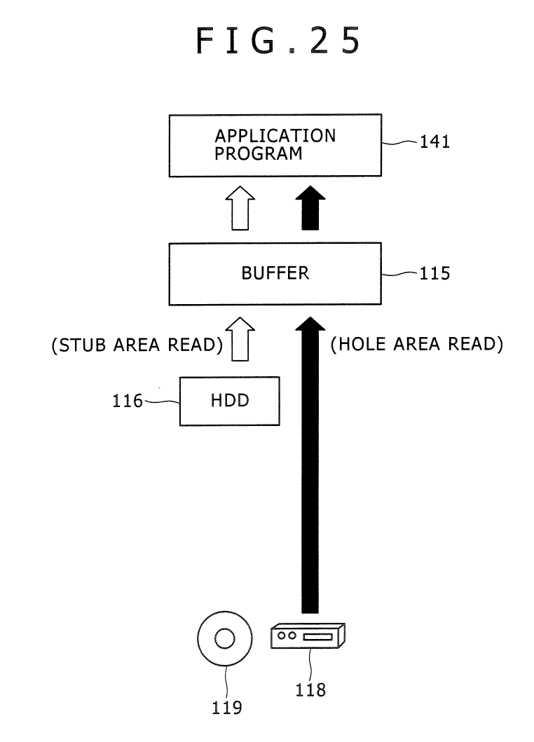

If content data not recorded in a cache file can be read out from an optical disk 119 mounted on the drive 118 in an operation to reproduce a content directly from the data read out from the optical disk 119, as shown in FIG. 25, data stored in the HDD 116 is read out from the HDD 116, but data not stored in the HDD 116 is read out by the drive 118 from an optical disk 119 mounted on the drive 118.

That is to say, data recorded in advance in the HDD 116 as the data of a stub area is read out from the HDD 116, supplied to the buffer 115 and temporarily stored in the buffer 115. On the other hand, data of a hole area not recorded in advance in the HDD 116 is read out by the drive 118 from an optical disk 119 mounted on the drive 118, supplied to the buffer 115 and temporarily stored in the buffer 115.

An application program 141 reads out the data temporarily stored in the buffer 115, outputting picture and sound signals.

Since data write processing carried out in the recording/reproduction system 101 shown in FIG. 24 is the same as the processing explained earlier by referring to the flowchart shown in FIG. 17, the explanation of the data write processing is not repeated.

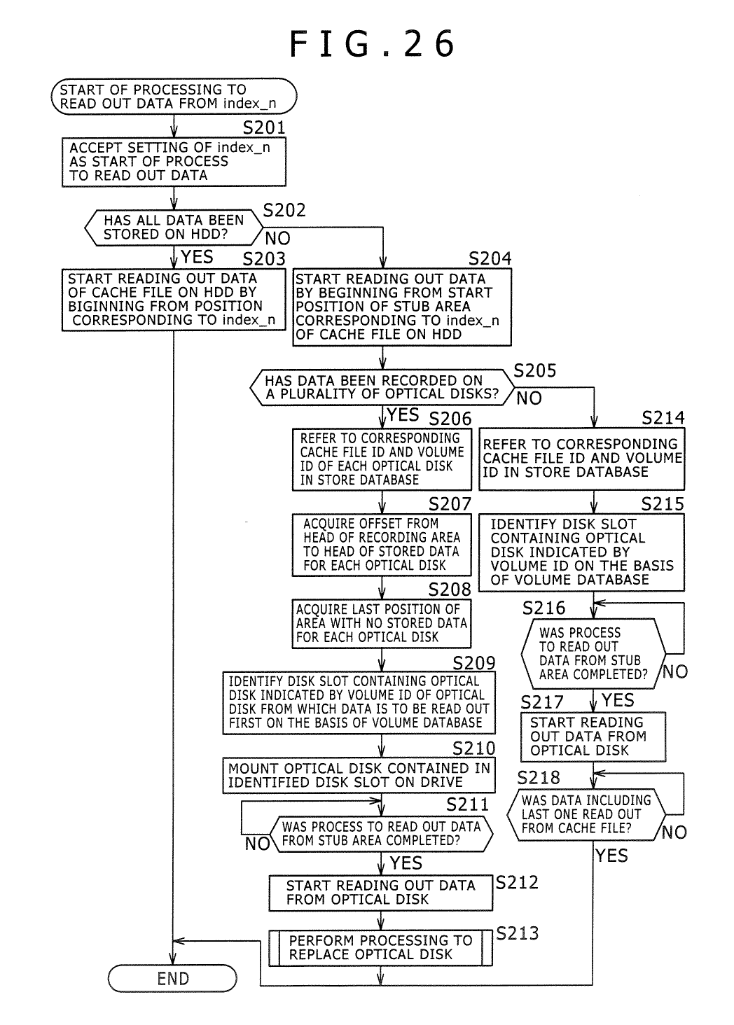

FIG. 26 shows a flowchart to be referred to in explanation of processing to read out content data starting at index_n in an operation to reproduce a content directly from specific data read out from the optical disk 119 mounted on the drive 118 because the specific data has not been stored yet in a cache file recorded in the HDD 116. Since steps S201 to S209 of the flowchart shown in this figure are identical with respectively the steps S131 to S139 of the flowchart shown in FIG. 20, the steps S201 to S209 are not described.

At a step S210, the storage server 165 gives a command to the media server 167 to mount an optical disk 119 accommodated in a disk slot 121 identified in the process carried out at the step S209 onto the drive 118. In accordance with this command, the media server 167 requests the juke system 120 through the changer driver 143 to mount an optical disk 119 accommodated in the identified disk slot 121 onto the drive 118. As requested, the juke system 120 executes control to drive the picker 122 employed in the juke box 145 to bring out the optical disk 119 from the identified disk slot 121, convey the optical disk 119 from the disk slot 121 to the drive 118 and place (mount) the optical disk 119 onto the drive 118.

Then, at the next step S211, the HSM apparatus 113 produces a result of determination as to whether or not the process to read out data of a stub area corresponding to specified index_n from the HDD 116 has been completed. If the determination result produced in the process carried out at the step S211 indicates that the process to read out data of a stub area corresponding to specified index_n from the HDD 116 has not been completed yet, the flow of the processing procedure goes back to the step S211 to repeat the determination process of the step. As a matter of fact, the determination process of the step S211 is carried out repeatedly till the determination result produced in the process carried out at the step S211 indicates that the process to read out data of a stub area corresponding to specified index_n from the HDD 116 has been completed.

As the determination result produced in the process carried out at the step S211 indicates that the process to read out data of a stub area corresponding to specified index_n from the HDD 116 has been completed, the flow of the processing procedure goes on to the step S212 at which the HSM apparatus 113 starts an operation to read out content data from the optical disk 119 mounted on the drive 118.

Then, at the next step S213, processing to replace the optical disk 119 mounted on the drive 118 with a next one is carried out. Details of the processing to replace the optical disk 119 mounted on the drive 118 with a next one will be described later with reference to a flowchart shown in FIG. 27.

Since steps S214 and S215 of the flowchart shown in this figure are identical with respectively the steps S140 and S141 of the flowchart shown in FIG. 20, the steps S214 and S215 are not described.

At the next step S216, the HSM apparatus 113 produces a result of determination as to whether or not the process to read out data of a stub area corresponding to specified index_n from the HDD 116 has been completed. If the determination result produced in the process carried out at the step S216 indicates that the process to read out data of a stub area corresponding to specified index_n from the HDD 116 has not been completed yet, the flow of the processing procedure goes back to the step S216 to repeat the determination process of the step. As a matter of fact, the determination process of the step S216 is carried out repeatedly till the determination result produced in the process carried out at the step S216 indicates that the process to read out data of a stub area corresponding to specified index_n from the HDD 116 has been completed.

As the determination result produced in the process carried out at the step S216 indicates that the process to read out data of a stub area corresponding to specified index_n from the HDD 116 has been completed, the flow of the processing procedure goes on to the step S217 at which the HSM apparatus 113 starts an operation to read out content data from the optical disk 119 mounted on the drive 118.

Then, at the next step S218, the storage manager 114 produces a result of determination as to whether or not the data has been read out till the end of the content. If the determination result produced in the process carried out at the step S218 indicates that the data has not been read out till the end of the content, the flow of the processing procedure goes back to the step S218 to repeat the determination process of the step. As a matter of fact, the determination process of the step S218 is carried out repeatedly till the determination result produced in the process carried out at the step S218 indicates that the data has been read out till the end of the content.

As the determination result produced in the process carried out at the step S218 indicates that the data has been read out till the end of the content, the execution of the processing to read out content data starting at index_n is ended.

FIG. 27 shows a flowchart to be referred to in explanation of the processing carried out at the step S213 to replace the optical disk 119 mounted on the drive 118 with a next one. At the first step S241 of the flowchart, the storage manager 114 produces a result of determination as to whether or not data has been read out till the end of the content. If the determination result produced in the process carried out at the step S241 indicates that data has not been read out till the end of the content, the flow of the processing procedure goes on to a step S242 at which, on the basis of the span included in the area information, the migration file system 164 produces a result of determination as to whether or not a process to read out data to the last position of an area with no stored data has been completed for the optical disk 119 mounted on the drive 118.

To put it in detail, if a stub area used for storing data with a sufficient amount allowing an operation of reading out content data from the HDD 116 to be carried out continuously without exhausting the HDD 116 during a period in which the optical disk 119 mounted presently on the drive 118 is replaced with the next one is placed at a location corresponding to content data stored in the vicinity of the head of the recording area of the next optical disk 119 containing data to be read out after the replacement of the optical disk 119 mounted presently on the drive 118 with the next optical disk 119, for example, the migration file system 164 produces a result of determination as to whether or not a process to read out data has been completed to the last position of a hole area, the data of which is being read out and, on the basis of the span included in the area information of the next stub area, the migration file system 164 also produces a result of determination as to whether or not the data the next stub data has been recorded on an optical disk 119 different from the optical disk 119 mounted presently on the drive 118 in order to produce a result of determination as to whether or not a process to read out data to the last position of an area with no stored data has been completed for the optical disk 119 mounted on the drive 118.

If a stub area used for storing data with a sufficient amount allowing an operation of reading out content data from the HDD 116 to be carried out continuously without exhausting the HDD 116 during a period in which the optical disk 119 mounted presently on the drive 118 is replaced with the next one is placed at a location corresponding to content data stored in the vicinity of the tail of the recording area of the optical disk 119 containing data to be read out prior to the replacement of the optical disk 119 mounted presently on the drive 118 with the next optical disk 119, for example, the migration file system 164 produces a result of determination as to whether or not a process to read out data has been completed to the last position of an area, the data of which is being read out and, on the basis of the span included in the area information of the next hole area, the migration file system 164 also produces a result of determination as to whether or not the data to be read out next has been recorded on an optical disk 119 different from the optical disk 119 mounted presently on the drive 118 in order to produce a result of determination as to whether or not a process to read out data to the last position of an area with no stored data has been completed for the optical disk 119 mounted on the drive 118.

It is to be noted that, at the step S242, as an alternative, on the basis of the position acquired in the process carried out at the step S208, the migration file system 164 may produce a result of determination as to whether or not a process to read out data to the last position of an area with no stored data has been completed for the optical disk 119 mounted on the drive 118.

If the determination result produced in the process carried out at the step S242 indicates that the process to read out data to the last position of an area with no stored data has not been completed yet, the process to read out data from the optical disk 119 mounted on the drive 118 is continued and the flow of the processing procedure goes back to the step S241 to repeat the determination process of this step.

If the determination result produced in the process carried out at the step S242 indicates that the process to read out data to the last position of an area with no stored data has been completed, on the other hand, the flow of the processing procedure goes on to a step S243 at which the migration file system 164 drives the storage server 165 to start an operation to read out content data from a stub area of a cache file recorded in the HDD 116. The content data read out from the HDD 116 in a read operation started at the step S243 is the stub data of a stub area placed at a location corresponding to content data recorded in the vicinity of the head of the recording area of an optical disk 119 mounted next on the drive 118, or the stub data of a stub area placed at a location corresponding to content data recorded in the vicinity of the tail of the recording area of the optical disk 119 already mounted on the drive 118.

Then, at the next step S244, the migration file system 164 drives the picker 122 to convey the optical disk 119 ejected out from the drive 118 to the disk slot 121 used for accommodating the optical disk 119 and restore the optical disk 119 to the disk slot 121.

Subsequently, at the next step S245, on the basis of the volume database 168, the migration file system 164 identifies a disk slot 121 used for accommodating an optical disk 119 identified by a volume ID assigned to an optical disk 119 from which data is to be read out next. Then, at the next step S246, the migration file system 164 drives the picker 122 to fetch an optical disk 119 from the identified disk slot 121, convey the optical disk 119 from the disk slot 121 to the drive 118 and mount the optical disk 119 onto the drive 118.

Subsequently, at the next step S247, the migration file system 164 produces a result of determination as to whether or not the operation to read out data of the stub data from the HDD 116 has been completed. If the determination result produced in the process carried out at the step S247 indicates that the process to read out data of the stub data from the HDD 116 has not been completed yet, the flow of the processing procedure goes back to the step S247 to repeat the determination process of this step. As a matter of fact, the determination process of the step S247 is carried out repeatedly till the determination result produced in the process carried out at this step indicates that the process to read out data of the stub data from the HDD 116 has been completed.

As the determination result produced in the process carried out at the step S247 indicates that the process to read out data of the stub data from the HDD 116 has been completed, the flow of the processing procedure goes on to a step S248 at which the migration file system 164 starts an operation to read out data of the content from the optical disk 119 mounted on the drive 118. Then, the flow of the processing procedure goes back to the step S241 to repeat the processes described so far.

If the determination result produced in the process carried out at the step S241 indicates that data has been read out till the end of the content, on the other hand, the execution of the processing to replace the optical disk 119 mounted on the drive 118 with a next one is ended.

As described above, data stored in a cache file recorded in the HDD 116 is read out from the HDD 116 whereas data not stored in a cache file recorded in the HDD 116 is read out by the drive 118 directly from an optical disk 119 mounted on the drive 118.

By implementing the system with the configuration described above, the number of accesses to the HDD 116 can be reduced. In addition, the size of the used recording area of the HDD 116 can be decreased.

After the next optical disk 119 has been placed (or mounted) on the drive 118, data of any portion included in the content as a portion including a hole area can be read out fast.

Note that it is possible to provide a configuration capable of properly transiting from the processing carried out by the recording/reproduction system 101 shown in FIG. 4 to the processing carried out by the recording/reproduction system 101 shown in FIG. 24 or vice versa.

In addition, a recorded content can be transmitted to an external recipient by way of a network.

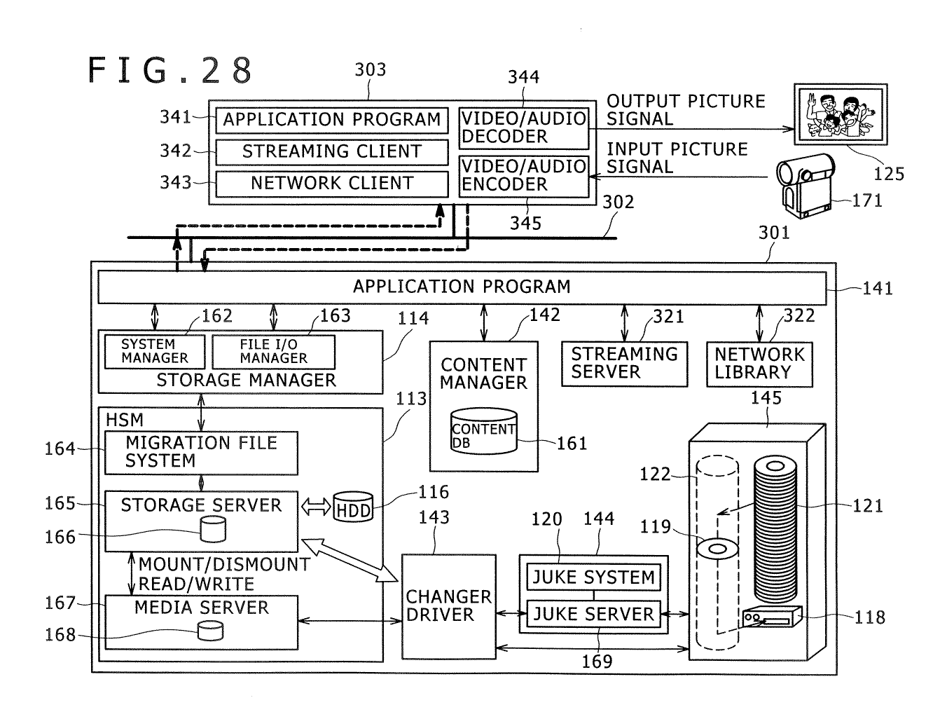

FIG. 28 is a block diagram showing a further configuration of the recording/reproduction system provided by the embodiment of the present invention as a system capable of transmitting a recorded content to an external recipient by way of a network.

Elements included in the configuration shown in the figure as elements identical with their respective counterparts employed in the configurations shown in FIG. 4 or 5 are denoted by the same reference numerals as the counterparts and description of the counterparts is not repeated.

The recording/reproduction system shown in FIG. 28 includes a server 301 and a client 303 connected to the server 301 by a network 302.

The configuration of the server 301 includes an HSM apparatus 113, a storage manager 114, an application program 141, a content manager 142, a changer driver 143, a juke-box control section 144, a juke box 145, a streaming server 321 and a network library 322.

The application program 141 receives a stream including picture and sound data transmitted by the client 303 by way of the network 302, supplying the stream to a file I/O manager 163. In addition, the application program 141 receives a stream supplied by the file I/O manager 163 and drives the streaming server 321 to transmit the stream.

The streaming server 321 is a section for transmitting a stream from the application program 141 to the client 303 by way of the network 302 on the basis of a procedure described in the network library 322. When the streaming server 321 receives a stream transmission request from the client 303 as a request for an operation to reproduce a content starting at a predetermined position, the streaming server 321 transmits a stream for reproducing the content from the predetermined position to the client 303 by way of the network 302.

The network library 322 includes procedures for transmitting data or a stream to the client 303 by way of the network 302 and receiving data or a stream transmitted by the client 303 by way of the network 302.

The network 302 is a radio or wire transmission medium for transmitting various kinds of data including a stream. Examples of the network 302 are a LAN such as a home network, the Internet, a public network and a dedicated network.

The configuration of the client 303 includes an application program 341, a streaming client 342, a network client 343, a video/audio decoder 344 and a video/audio encoder 345.

The application program 341 has the function of an interface with the user. To be more specific, the application program 341 is a section for receiving a command issued by the user and notifying the user of various kinds of information on the client 303. The application program 341 also controls the whole of the client 303.

The streaming client 342 is a section for receiving a stream transmitted by the server 301 by way of the network 302 and supplying the received stream to the video/audio decoder 344. The network client 343 is a section for exchanging various kinds of data with the server 301 by way of the network 302. To be more specific, the network client 343 transmits a stream received from the video/audio encoder 345 to the server 301 by way of the network 302. In addition, the network client 343 also transmits a stream transmission request to the server 301 by way of the network 302 as a request for an operation to reproduce a content starting at a predetermined position.

The video/audio decoder 344 is a section for splitting a stream into encoded picture data and sound data. The video/audio decoder 344 decodes the encoded picture and sound data to generate the so-called base-band picture and sound data respectively. The video/audio decoder 344 then supplies output picture and sound signals based on respectively the base-band picture and sound data obtained as a result of the decoding process to a monitor 125. It is to be noted that the output sound signal itself is not shown in the figure.

The video/audio encoder 345 is a section for receiving input picture and sound signals from a video camera 171 and converting the received input picture and sound signals into base-band picture and sound data respectively. The video/audio encoder 345 encodes the base-band picture and sound data and multiplexes the encoded base-band picture and sound data in order to generate a stream. The video/audio encoder 345 then supplies the generated stream to the network client 343.

In this way, the server 301 is capable of transmitting a stream used for reproducing a content from a desired position to the client 303 by way of the network 302 at a high speed.

As described above, in accordance with the present invention, it is possible to reduce the number of cases in which a wait time is generated without requiring cumbersome operations in an attempt to read out any arbitrary portion of a content.

Also as described above, an operation to read out the data of a content from first and second recording mediums can be prevented from being suspended during a period of switching the data reading operation from the first recording medium to the second recording medium by controlling an operation to record partial data of the content onto a third recording medium so as to give such an amount of the partial data recorded on the third recording medium that an operation carried out during the period of switching the data reading operation from the first recording medium to the second recording medium to read out the partial data from the third recording medium does not exhaust the third recording medium. In addition, the operation to read out the data of a content from first and second recording mediums can be prevented from being suspended during a period of switching the data reading operation from the first recording medium to the second recording medium by controlling an operation to read out the data of a content from first, second and third recording mediums so as to read out the partial data of the content from the third recording medium during the period of switching the data reading operation from the first recording medium to the second recording medium.

It is to be noted that, as the primary storage device, a high-speed recording medium such as a semiconductor memory can be used in place of the HDD 116. In addition, as the secondary storage device, it is possible to employ a recording medium having a low price in comparison with the primary storage device in place of the optical disk 119. Examples of the recording medium having a low price are a magnetic disk and a magnetic tape.

In addition, the content is not limited to pictures and sounds. That is to say, the content can be any content as long as the data of the content is continuous along the time axis and useful to the user. Examples of the data of a usable content are data used in a game, data measured from time to time and data computed from time to time as a result of simulation.

The series of processes described previously can be carried out by hardware and/or execution of software. If the series of processes described above is carried out by execution of software, programs composing the software can be installed into a computer embedded in dedicated hardware, a general-purpose personal computer or the like from typically a network or a mounted recording medium. By installing a variety of programs into the general-purpose personal computer, the personal computer is capable of carrying out a variety of functions.

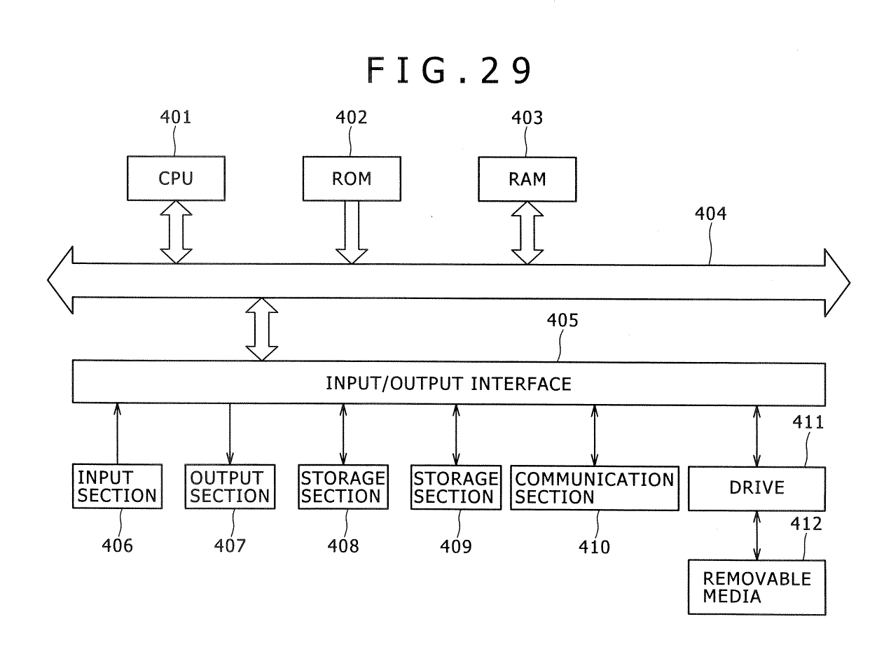

FIG. 29 is a block diagram showing the configuration of a personal computer for carrying out the series of processes described previously by execution of programs. In the configuration, a CPU (Central Processing Unit) 401 carries out various kinds of processing by execution of the programs stored in an embedded recording medium such as a ROM (Read Only Memory) 402 in advance or installed programs loaded from a storage section 408 or 409 into a RAM (Random Access Memory) 403. As will be described later, the programs installed in the storage section 408 or 409 are programs downloaded from a network or programs transferred from the mounted recording medium mentioned above. In addition to the programs loaded from the storage section 408 or 409 to be executed by the CPU 401, the RAM 403 is also used for properly storing various kinds of information such as data required in execution of the processing. The CPU 401, the ROM 402 and the RAM 403 are connected to each other by a bus 404.

It is to be noted that, as the CPU 401, a cell can be employed. The cell is described on pages 89 to 117 of Nikkei Electronics Magazine published by Nikkei BP Corporation on Feb. 28, 2005 as a news article with a title of “Cell Birth.”

The CPU 401 is thus connected to the input/output interface 405 through the bus 404. The input/output interface 405 is connected to an input section 406, an output section 407, the storage section 408 cited above, the other storage section 409 mentioned above, a communication section 410 and a drive 411. The input section 406 includes a keyboard and a mouse whereas the output section 407 includes a display unit and a speaker. The CPU 401 carries out various kinds of processing in accordance with commands entered by the user via the input section 406. In addition, the CPU 401 outputs results of the processing to the output section 407.

Used for storing the programs to be executed by the CPU 401 and various kinds of data, the storage section 408 connected to the input/output interface 405 corresponds to the HDD 116 described before. Also used for storing the programs to be executed by the CPU 401 and various kinds of data, the other storage section 409 corresponds typically to the juke box 145. The communication section 410 is a unit for carrying out communication processing with other apparatus such as the client 303 through the network 302 such as the Internet or a LAN.

As described above, the programs can be installed into the personal computer from a network. In this case, the programs are downloaded from the network through the communication section 410 into the storage section 408 or 409 for execution by the CPU 401.

As described above, the input/output interface 405 is also connected to the drive 411 on which the mounted recording medium mentioned before is mounted. The mounted recording medium is removable media 412, which can be a magnetic disk, an optical disk, a magneto-optical disk or a semiconductor memory. When the removable media 412 is mounted on the drive 411, the drive 411 drives the removable media 412 in order to read out a program and/or data from the removable media 412. The drive 411 then supplies the acquired program and/or data to the storage section 408 or 409 to be recorded therein.

As mentioned above, the series of processes described previously can be carried out by hardware and/or execution of software. If the series of processes described above is carried out by execution of software, programs composing the software can be installed into a computer embedded in dedicated hardware, a general-purpose personal computer or the like from the mounted recording medium, which is the removable media 412 as explained above. By installing a variety of programs into the general-purpose personal computer, the personal computer is capable of carrying out a variety of functions.

As is obvious from the above description, the aforementioned recording medium for recording programs to be installed into a computer or a general-purpose personal computer as programs to be executed by the computer or the general-purpose personal computer respectively is the removable media 412 shown in FIG. 29. To put it concretely, the aforementioned examples of the removable media 412, which is also referred to as a package medium, include a magnetic disk such as a flexible disk, an optical disk such as a CD-ROM (Compact Disk-Read Only Memory) or a DVD (Digital Versatile Disk), a magneto-optical disk such as an MD (Mini Disk) as well as a semiconductor memory. Instead of installing the programs from the removable media 412 or a network, the programs can also be stored in advance in an embedded recording medium used for storing the programs temporarily or permanently. Examples of the embedded recording medium are a hard disk included in the storage section 408 and the ROM 402. As mentioned above, if necessary, the programs can also be downloaded from a network into the storage section 408 and/or 409 by way of the communication section 410 serving as an interface with the network. Examples of the communication section 410 are a router or a modem. The network such as a LAN (local area network), the Internet or a digital broadcasting satellite serves as a wire or radio communication medium.

It is also worth noting that, in this specification, steps of the flowchart described above can be carried out not only in a pre-prescribed order along the time axis, but also concurrently or individually.

In addition, the technical term ‘system’ used in this specification implies the configuration of a confluence including a plurality of apparatus.

It is also to be noted that implementations of the present invention are not limited to the embodiments described above. The embodiments may be changed to modified versions within a range not deviating from the critical points of the present invention. In other words, it should be understood by those skilled in the art that a variety of modifications, combinations, sub-combinations and alterations may occur in dependence on design requirements and other factors insofar as they are within the scope of the appended claims or the equivalents thereof.

What is claimed is:

1. A recording apparatus comprising:
a first recording medium configured to record a front portion included in the entire data of a content continuous along the time axis as a part of said content;
a second recording medium configured to record a portion included in the entire data of said content as a part following said front portion recorded on said first recording medium;
a third recording medium configured to record partial data of said content; and
recording control means configured to control a process of recording data onto said third recording medium so as to record as much partial data of said content onto said third recording medium as data having a first data amount representing the amount of data, which can be read out from said third recording medium without exhausting said third recording medium during a period to switch an operation to read out data from said first recording medium to said second recording medium.

2. The recording apparatus according to claim 1, wherein said recording control means is capable of controlling a process of recording data onto said third recording medium so as to record as much partial data of said content onto said third recording medium, which can be read out from said third recording medium without exhausting said third recording medium during a period to switch an operation to read out data from said first recording medium to said second recording medium.

3. The recording apparatus according to claim 1, wherein said recording control means is capable of controlling a process of recording data onto said third recording medium on the basis of a second data amount representing the amount of data stored in said first recording medium but not stored in said third recording medium as data of said content and on the basis of said first data amount determined in accordance with a speed at which data is read out from said first recording medium.

4. The recording apparatus according to claim 1, said recording apparatus further including computation means configured to compute said first data amount, wherein said recording control means is capable of controlling a process of recording data onto said third recording medium so as to record as much partial data of said content onto said third recording medium as data having said first data amount computed by said computation means.

5. The recording apparatus according to claim 1, wherein, when a reading apparatus for reading data of a content from said first, second or third recording medium reads out data of a content from said first or second recording medium, stores said data onto said third recording medium and then reads out said data from said third recording medium, said recording control means is capable of controlling a process of recording data onto said third recording medium so as to record as much front partial data of said content onto said third recording medium as data having said first data amount.

6. The recording apparatus according to claim 1, said recording apparatus further including storage means configured to store information indicating whether or not each content data portion recorded on said second recording medium as a portion, which can be a data portion already recorded or not recorded yet on said third recording medium, is a data portion following data already recorded on said first recording medium.

7. A recording method to be adopted by a recording apparatus comprising:
a first recording medium configured to record a front portion included in the entire data of a content continuous along the time axis as a part of said content;
a second recording medium configured to record a portion included in the entire data of said content as a part following said front portion recorded on said first recording medium; and
a third recording medium configured to record partial data of said content;
whereby a recording control step is executed as the step of controlling a process of recording data onto said third recording medium so as to record as much partial data of said content onto said third recording medium as data having a first data amount representing the amount of data, which can be read out from said third recording medium without exhausting said third recording medium during a period to switch an operation to read out data from said first recording medium to said second recording medium.

8. A program to be executed by a computer employed in a recording apparatus comprising:
a first recording medium configured to record a front portion included in the entire data of a content continuous along the time axis as a part of said content;
a second recording medium configured to record a portion included in the entire data of said content as a part following said front portion recorded on said first recording medium; and
a third recording medium configured to record partial data of said content;
wherein said program is executed by said computer to carry out the recording control step of controlling a process of recording data onto said third recording medium so as to record as much partial data of said content onto said third recording medium as data having a data amount representing the amount of data, which can be read out from said third recording medium without exhausting said third recording medium during a period to switch an operation to read out data from said first recording medium to said second recording medium.

9. A reading apparatus comprising:
a first recording medium configured to record a front portion included in the entire data of a content continuous along the time axis as a part of said content;
a second recording medium configured to record a portion included in the entire data of said content as a part following said front portion recorded on said first recording medium;
a third recording medium configured to record as much partial data of said content as data having a data amount representing the amount of data, which can be read out without exhausting said third recording medium during a period to switch an operation to read out data from said first recording medium to said second recording medium; and
reading control means configured to control a process of reading out data from said first, second or third recording medium so as to read out data of said content from said third recording medium without exhausting said third recording medium during a period to switch an operation to read out data from said first recording medium to said second recording medium.

10. The reading apparatus according to claim 9, wherein said reading control means is capable of controlling a process of reading out data of a content so as to read out said data of said content from said first or second recording medium, store said data onto said third recording medium and then read out said data from said third recording medium.

11. The reading apparatus according to claim 10, wherein said reading control means is capable of executing control to record data read out from said first or second recording medium but not stored yet in advance on said third recording medium onto said third recording medium.

12. The reading apparatus according to claim 9, wherein said reading control means is capable of controlling an operation to read out data from said first or second recording medium so as to read out data not recorded yet on said third recording medium from said first or second recording medium as data of said content.

13. The reading apparatus according to claim 9, wherein said reading control means is capable of controlling an operation to read out data from said first or second recording medium so as to read out data at a high reading speed in comparison with ordinary read operations from said first or second recording medium.

14. A reading method to be adopted in a reading apparatus comprising:
a first recording medium configured to record a front portion included in the entire data of a content continuous along the time axis as a part of said content;
a second recording medium configured to record a portion included in the entire data of said content as a part following said front portion recorded on said first recording medium; and
a third recording medium configured to record as much partial data of said content as data having a data amount representing the amount of data, which can be read out without exhausting said third recording medium during a period to switch an operation to read out data from said first recording medium to said second recording medium,
whereby a step is executed as the step of controlling a process to read out data from said first, second or third recording medium so as to read out data of said content from said third recording medium without exhausting said third recording medium during a period to switch an operation to read out data from said first recording medium to said second recording medium.

15. A program to be executed by a computer employed in a reading apparatus comprising:
a first recording medium configured to record a front portion included in the entire data of a content continuous along the time axis as a part of said content;
a second recording medium configured to record a portion included in the entire data of said content as a part following said front portion recorded on said first recording medium; and
a third recording medium configured to record as much partial data of said content as data having a data amount representing the amount of data, which can be read out without exhausting said third recording medium during a period to switch an operation to read out data from said first recording medium to said second recording medium;
wherein said program is executed by said computer to carry out the step of controlling a process to read out data from said first, second or third recording medium so as to read out data of said content from said third recording medium without exhausting said third recording medium during a period to switch an operation to read out data from said first recording medium to said second recording medium.
